(19) United States
(12) Patent Application Publication
(10) Pub. No.: US 2026/0035086 A1
(43) Pub. Date: Feb. 5, 2026

(54) OPEN ROTOR AIRCRAFT PROPULSION SYSTEM WITH MULTI-GEAR SYSTEM GEARTRAIN

(71) Applicant: RTX Corporation, Farmington, CT (US)

(72) Inventors: Jeffrey T. Morton, Manchester, CT (US); Andrew E. Breault, Bolton, CT (US); Roger Gates, West Hartford, CT (US)

(21) Appl. No.: 19/353,260

(22) Filed: Oct. 8, 2025

Related U.S. Application Data
(63) Continuation-in-part of application No. 18/777,123, filed on Jul. 18, 2024.

(51) Int. Cl. B64D 35/06; B64D 27/14; F16H 1/46

(52) U.S. Cl. CPC B64D 35/06; B64D 27/14; F16H 1/46

(57) ABSTRACT

A first propulsion system includes a first open propulsor rotor, a first open guide vane structure, a first engine core and a first geartrain. The first engine core includes a first rotating structure configured to drive rotation of the first open propulsor rotor in a first rotational direction about a first axis through the first geartrain. A second propulsion system includes a second open propulsor rotor, a second open guide vane structure, a second engine core and a second geartrain. The second engine core includes a second rotating structure configured to drive rotation of the second open propulsor rotor in a second rotational direction about a second axis through the second geartrain. The first and the second geartrains each include a plurality of epicyclic gear systems operatively coupled in series between the respective rotating structure and the respective open propulsor rotor.

### CROSS-REFERENCE TO RELATED APPLICATIONS

This application claims priority to and is a continuation-in-part of U.S. patent application Ser. No. 18/777,123 filed Jul. 18, 2024, which is hereby incorporated herein by reference in its entirety.

### BACKGROUND OF THE DISCLOSURE

### 1. Technical Field

This disclosure relates generally to an aircraft and, more particularly, to propulsion system(s) for the aircraft.

### 2. Background Information

Various types and configurations of aircraft propulsion systems are known in the art including those with one or more open propulsor rotors. While these known aircraft propulsion systems have various benefits, there is still room in the art for improvement.

### SUMMARY OF THE DISCLOSURE

According to an aspect of the present disclosure, an assembly is provided for an aircraft. This aircraft assembly includes a first propulsion system and a second propulsion system. The first propulsion system includes a first open propulsor rotor, a first open guide vane structure, a first engine core and a first geartrain. The first engine core includes a first rotating structure configured to drive rotation of the first open propulsor rotor in a first rotational direction about a first axis through the first geartrain. The first rotating structure includes a first turbine rotor. The first geartrain includes a first plurality of epicyclic gear systems operatively coupled in series between the first rotating structure and the first open propulsor rotor. The second propulsion system includes a second open propulsor rotor, a second open guide vane structure, a second engine core and a second geartrain. The second engine core includes a second rotating structure configured to drive rotation of the second open propulsor rotor in a second rotational direction about a second axis through the second geartrain. The second rotating structure includes a second turbine rotor. The second geartrain includes a second plurality of epicyclic gear systems operatively coupled in series between the second rotating structure and the second open propulsor rotor.

According to another aspect of the present disclosure, another assembly is provided for an aircraft. This aircraft assembly includes a first propulsion system, a second propulsion system, a third propulsion system and a fourth propulsion system. The first propulsion system includes a first open propulsor rotor and a first engine core. The first open propulsor rotor includes a first number of first open propulsor blades arranged in an array about a first axis. The first engine core includes a first rotating structure configured to drive rotation of the first open propulsor rotor in a first rotational direction about the first axis. The first number is equal to or greater than nine. The second propulsion system includes a second open propulsor rotor and a second engine core. The second open propulsor rotor includes a second number of second open propulsor blades arranged in an array about a second axis. The second engine core includes a second rotating structure configured to drive rotation of the second open propulsor rotor in the first rotational direction about the second axis. The second number is equal to or greater than nine. The third propulsion system includes a third open propulsor rotor and a third engine core. The third open propulsor rotor includes a third number of third open propulsor blades arranged in an array about a third axis. The third engine core includes a third rotating structure configured to drive rotation of the third open propulsor rotor in a second rotational direction about the third axis. The third number is equal to or greater than nine. The fourth propulsion system includes a fourth open propulsor rotor and a fourth engine core. The fourth open propulsor rotor includes a fourth number of fourth open propulsor blades arranged in an array about a fourth axis. The fourth engine core includes a fourth rotating structure configured to drive rotation of the fourth open propulsor rotor in the second rotational direction about the fourth axis. The fourth number is equal to or greater than nine.

According to another aspect of the present disclosure, another assembly is provided for an aircraft. This aircraft assembly includes a first propulsion system, a second propulsion system, a third propulsion system and a fourth propulsion system. The first propulsion system includes a first open propulsor rotor, a first open guide vane structure and a first engine core. The first engine core includes a first rotating structure configured to drive rotation of the first open propulsor rotor in a first rotational direction about a first axis. The second propulsion system includes a second open propulsor rotor, a second open guide vane structure and a second engine core. The second engine core includes a second rotating structure configured to drive rotation of the second open propulsor rotor in the first rotational direction about a second axis. The third propulsion system includes a third open propulsor rotor, a third open guide vane structure and a third engine core. The third engine core includes a third rotating structure configured to drive rotation of the third open propulsor rotor in a second rotational direction about a third axis. The fourth propulsion system includes a fourth open propulsor rotor, a fourth open guide vane structure and a fourth engine core. The fourth engine core includes a fourth rotating structure configured to drive rotation of the fourth open propulsor rotor in the second rotational direction about a fourth axis.

According to another aspect of the present disclosure, an assembly is provided for an aircraft that includes a first propulsion system and a second propulsion system. Each of the first propulsion system and the second propulsion system includes an open propulsor rotor and a turbine engine configured to drive rotation of the open propulsor rotor. The open propulsor rotor includes a plurality of open propulsor blades. The turbine engine includes a compressor section, a combustor section, a turbine section, a first rotating structure, a second rotating structure and a flowpath. The first rotating structure includes a first bladed rotor. The second rotating structure includes a second bladed rotor and is operable to rotate independent of the first rotating structure. The flowpath extends through the compressor section, the combustor section and the turbine section with the first bladed rotor disposed between the second bladed rotor and the combustor section along the flowpath. The open propulsor rotor of the first propulsion system is configured to rotate a first rotational direction and has a first propulsor rotation parameter equal to positive one. The open propulsor rotor of the second propulsion system is configured to rotate a second rotational direction, that is opposite the first rotational direction, and has a second propulsor rotation parameter equal to negative one. The first bladed rotor of the first propulsion system has a first system first rotor rotation parameter equal to positive one where the first bladed rotor of the first propulsion system is configured to rotate in the first rotational direction or negative one where the first bladed rotor of the first propulsion system is configured to rotate in the second rotational direction. The first bladed rotor of the second propulsion system has a second system first rotor rotation parameter equal to positive one where the first bladed rotor of the second propulsion system is configured to rotate in the first rotational direction or negative one where the first bladed rotor of the second propulsion system is configured to rotate in the second rotational direction. The second bladed rotor of the first propulsion system has a first system second rotor rotation parameter equal to positive one where the second bladed rotor of the first propulsion system is configured to rotate in the first rotational direction or negative one where the second bladed rotor of the first propulsion system is configured to rotate in the second rotational direction. The second bladed rotor of the second propulsion system has a second system second rotor rotation parameter equal to positive one where the second bladed rotor of the second propulsion system is configured to rotate in the first rotational direction or negative one where the second bladed rotor of the second propulsion system is configured to rotate in the second rotational direction. A sum of the first propulsor rotation parameter, the second propulsor rotation parameter, the first system first rotor rotation parameter, the second system first rotor rotation parameter, the first system second rotor rotation parameter and the second system second rotor rotation parameter is equal to zero.

According to another aspect of the present disclosure, another assembly is provided for an aircraft that includes a first propulsion system and a second propulsion system. Each of the first propulsion system and the second propulsion system includes an open propulsor rotor and a turbine engine configured to drive rotation of the open propulsor rotor. The open propulsor rotor includes a plurality of open propulsor blades. The turbine engine includes a compressor section, a combustor section, a turbine section, a first rotating structure, a second rotating structure and a flowpath. The first rotating structure includes a first bladed rotor. The second rotating structure includes a second bladed rotor and is operable to rotate independent of the first rotating structure. The flowpath extends through the compressor section, the combustor section and the turbine section with the first bladed rotor disposed between the second bladed rotor and the combustor section along the flowpath. The open propulsor rotor of the first propulsion system is configured to rotate a first rotational direction and has a first propulsor rotation parameter equal to positive one. The open propulsor rotor of the second propulsion system is configured to rotate a second rotational direction, that is opposite the first rotational direction, and has a second propulsor rotation parameter equal to negative one. The first bladed rotor of the first propulsion system has a first system first rotor rotation parameter equal to positive one where the first bladed rotor of the first propulsion system is configured to rotate in the first rotational direction or negative one where the first bladed rotor of the first propulsion system is configured to rotate in the second rotational direction. The first bladed rotor of the second propulsion system has a second system first rotor rotation parameter equal to positive one where the first bladed rotor of the second propulsion system is configured to rotate in the first rotational direction or negative one where the first bladed rotor of the second propulsion system is configured to rotate in the second rotational direction. The second bladed rotor of the first propulsion system has a first system second rotor rotation parameter equal to positive one where the second bladed rotor of the first propulsion system is configured to rotate in the first rotational direction or negative one where the second bladed rotor of the first propulsion system is configured to rotate in the second rotational direction. The second bladed rotor of the second propulsion system has a second system second rotor rotation parameter equal to positive one where the second bladed rotor of the second propulsion system is configured to rotate in the first rotational direction or negative one where the second bladed rotor of the second propulsion system is configured to rotate in the second rotational direction. A product of the first propulsor rotation parameter, the first system first rotor rotation parameter and the first system second rotor rotation parameter is equal to a first value. A product of the second propulsor rotation parameter, the second system first rotor rotation parameter and the second system second rotor rotation parameter is equal to a second value. A sum of the first value and the second value is equal to zero.

According to still another aspect of the present disclosure, another assembly is provided for an aircraft that includes a first propulsion system and a second propulsion system. Each of the first propulsion system and the second propulsion system includes an open propulsor rotor and a turbine engine configured to drive rotation of the open propulsor rotor. The turbine engine includes a compressor section, a combustor section, a turbine section, a first rotating structure, a second rotating structure and a flowpath. The first rotating structure includes a first bladed rotor. The second rotating structure includes a second bladed rotor and is operable to rotate independent of the first rotating structure. The flowpath extends through the compressor section, the combustor section and the turbine section with the first bladed rotor disposed between the second bladed rotor and the combustor section along the flowpath. The open propulsor rotor of the first propulsion system is configured to rotate a first rotational direction and has a first propulsor rotation parameter equal to positive one. The open propulsor rotor of the second propulsion system is configured to rotate a second rotational direction, that is opposite the first rotational direction, and has a second propulsor rotation parameter equal to negative one. The first bladed rotor of the first propulsion system has a first system first rotor rotation parameter equal to positive one where the first bladed rotor of the first propulsion system is configured to rotate in the first rotational direction or negative one where the first bladed rotor of the first propulsion system is configured to rotate in the second rotational direction. The first bladed rotor of the second propulsion system has a second system first rotor rotation parameter equal to positive one where the first bladed rotor of the second propulsion system is configured to rotate in the first rotational direction or negative one where the first bladed rotor of the second propulsion system is configured to rotate in the second rotational direction. The second bladed rotor of the first propulsion system has a first system second rotor rotation parameter equal to positive one where the second bladed rotor of the first propulsion system is configured to rotate in the first rotational direction or negative one where the second bladed rotor of the first propulsion system is configured to rotate in the second rotational direction. The second bladed rotor of the second propulsion system has a second system second rotation parameter equal to positive one where the second bladed rotor of the second propulsion system is configured to rotate in the first rotational direction or negative one where the second bladed rotor of the second propulsion system is configured to rotate in the second rotational direction. An absolute value of a sum of the first propulsor rotation parameter, the second propulsor rotation parameter, the first system first rotor rotation parameter, the second system first rotor rotation parameter, the first system second rotor rotation parameter and the second system second rotor rotation parameter is equal to or less than two. A product of the first propulsor rotation parameter, the first system first rotor rotation parameter and the first system second rotor rotation parameter is equal to a first value. A product of the second propulsor rotation parameter, the second system first rotor rotation parameter and the second system second rotor rotation parameter is equal to a second value. A sum of the first value and the second value is equal to zero.

The assembly may also include an aircraft fuselage extending laterally between a first side and a second side. The first propulsion system may be located laterally between the second propulsion system and the first side of the aircraft fuselage. The third propulsion system may be located laterally between the fourth propulsion system and the second side of the aircraft fuselage.

The assembly may also include an aircraft fuselage extending laterally between a first side and a second side. The first propulsion system may be located laterally between the third propulsion system and the first side of the aircraft fuselage. The second propulsion system may be located laterally between the fourth propulsion system and the second side of the aircraft fuselage.

The first propulsion system may also include a first open guide vane structure axially next to and downstream of the first open propulsor rotor. The second propulsion system may also include a second open guide vane structure axially next to and downstream of the second open propulsor rotor. The third propulsion system may also include a third open guide vane structure axially next to and downstream of the third open propulsor rotor. The fourth propulsion system may also include a fourth open guide vane structure axially next to and downstream of the fourth open propulsor rotor.

The first plurality of epicyclic gear systems may include a first star gear system and a first planetary gear system. The second plurality of epicyclic gear systems may include a second star gear system and a third star gear system.

The first plurality of epicyclic gear systems may include a first gear system and a second gear system. The first gear system may include: a sun gear configured to rotate about the first axis; a ring gear configured to rotate about the first axis; a plurality of intermediate gears meshed with and radially between the sun gear and the ring gear; and a stationary carrier. Each of the intermediate gears may be rotatably mounted to the stationary carrier.

The first rotating structure may be operatively coupled to the first geartrain through the sun gear.

The second gear system may be operatively coupled to the first gear system through the ring gear.

The first plurality of epicyclic gear systems may include a first gear system and a second gear system. The second gear system may include: a sun gear configured to rotate about the first axis; a stationary ring gear; a plurality of intermediate gears meshed with and radially between the sun gear and the stationary ring gear; and a carrier configured to rotate about the first axis. Each of the intermediate gears may be rotatably mounted to the carrier.

The first open propulsor rotor may be operatively coupled to the first geartrain through the carrier.

The first gear system may be operatively coupled to the second gear system through the sun gear.

The first open guide vane structure may include a plurality of open guide vanes arranged circumferentially about the first axis. The first open guide vane structure may be axially next to and downstream of the first open propulsor rotor.

A configuration of the first rotating structure may be identical to a configuration of the second rotating structure.

The assembly may also include an aircraft fuselage arranged laterally between the first propulsion system and the second propulsion system.

The assembly may also include an aircraft fuselage. The first propulsion system may be arranged laterally between the aircraft fuselage and the second propulsion system.

The assembly may also include a third propulsion system and/or a fourth propulsion system. The third propulsion system may include a third open propulsor rotor, a third open guide vane structure, a third engine core and a third geartrain. The third engine core may include a third rotating structure configured to drive rotation of the third open propulsor rotor in the first rotational direction about a third axis through the third geartrain. The third rotating structure may include a third turbine rotor. The fourth propulsion system may include a fourth open propulsor rotor, a fourth open guide vane structure, a fourth engine core and a fourth geartrain. The fourth engine core may include a fourth rotating structure configured to drive rotation of the fourth open propulsor rotor in the second rotational direction about a fourth axis through the fourth geartrain. The fourth rotating structure may include a fourth turbine rotor.

The assembly may also include an aircraft fuselage extending laterally between a first side and a second side. The first propulsion system and the second propulsion system may be arranged to the first side of the aircraft fuselage. The third propulsion system and the fourth propulsion system may be arranged to the second side of the aircraft fuselage.

The first propulsion system may be disposed laterally between the second propulsion system and the first side of the aircraft fuselage. In addition or alternatively, the third propulsion system may be disposed laterally between the fourth propulsion system and the second side of the aircraft fuselage.

The second propulsion system may be disposed laterally between the first propulsion system and the first side of the aircraft fuselage. In addition or alternatively, the fourth propulsion system may be disposed laterally between the third propulsion system and the second side of the aircraft fuselage.

The assembly may also include an aircraft fuselage extending laterally between a first side and a second side. The first propulsion system and the third propulsion system may be arranged to the first side of the aircraft fuselage. The second propulsion system and the fourth propulsion system may be arranged to the second side of the aircraft fuselage.

The turbine engine of the first propulsion system may also include a first engine third rotating structure operatively coupled to the open propulsor rotor of the first propulsion system. The first engine third rotating structure may include a first engine third structure bladed rotor disposed within the turbine section of the first propulsion system. The first engine third structure bladed rotor may have a first system third rotor rotation parameter equal to positive one where the first engine third structure bladed rotor is configured to rotate in the first rotational direction or negative one where the first engine third structure bladed rotor is configured to rotate in the second rotational direction. The turbine engine of the second propulsion system may also include a second engine third rotating structure operatively coupled to the open propulsor rotor of the second propulsion system. The second engine third rotating structure may include a second engine third structure bladed rotor disposed within the turbine section of the second propulsion system. The second engine third structure bladed rotor may have a second system third rotor rotation parameter equal to positive one where the second engine third structure bladed rotor is configured to rotate in the first rotational direction or negative one where the second engine third structure bladed rotor is configured to rotate in the second rotational direction. A product of the first propulsor rotation parameter, the first system first rotor rotation parameter, the first system second rotor rotation parameter and the first system third rotor rotation parameter may be equal to a third value. A product of the second propulsor rotation parameter, the second system first rotor rotation parameter, the second system second rotor rotation parameter and the second system third rotor rotation parameter may be equal to a fourth value. A sum of the third value and the fourth value may be equal to zero.

The open propulsor rotor may include at least nine of the open propulsor blades.

The open propulsor rotor may include at least twelve of the open propulsor blades.

The first bladed rotor of the first propulsion system and the first bladed rotor of the second propulsion system may be configured to rotate in a common rotational direction.

The first bladed rotor of the first propulsion system and the first bladed rotor of the second propulsion system may be configured to rotate in opposite rotational directions.

The second bladed rotor of the first propulsion system and the second bladed rotor of the second propulsion system may be configured to rotate in a common rotational direction.

The second bladed rotor of the first propulsion system and the second bladed rotor of the second propulsion system may be configured to rotate in opposite rotational directions.

The first bladed rotor of each of the first propulsion system and the second propulsion system may be configured as or otherwise include a first bladed compressor rotor. The second bladed rotor of each of the first propulsion system and the second propulsion system may be configured as or otherwise include a second bladed compressor rotor.

The first bladed rotor of each of the first propulsion system and the second propulsion system may be configured as or otherwise include a first bladed turbine rotor. The second bladed rotor of each of the first propulsion system and the second propulsion system may be configured as or otherwise include a second bladed turbine rotor.

The first bladed rotor of the first propulsion system may be next to the second bladed rotor of the first propulsion system along the flowpath of the first propulsion system. The first bladed rotor of the second propulsion system may be next to the second bladed rotor of the second propulsion system along the flowpath of the second propulsion system.

The second rotating structure of the first propulsion system may be operatively coupled to and configured to drive the rotation of the open propulsor rotor of the first propulsion system. The second rotating structure of the second propulsion system may be operatively coupled to and configured to drive the rotation of the open propulsor rotor of the second propulsion system.

The turbine engine of the first propulsion system may also include a first engine third rotating structure operatively coupled to the open propulsor rotor of the first propulsion system. The first engine third rotating structure may include a first engine third structure bladed rotor disposed within the turbine section of the first propulsion system. The first engine third structure bladed rotor may have a first system third rotor rotation parameter equal to positive one where the first engine third structure bladed rotor is configured to rotate in the first rotational direction or negative one where the first engine third structure bladed rotor is configured to rotate in the second rotational direction. The turbine engine of the second propulsion system may also include a second engine third rotating structure operatively coupled to the open propulsor rotor of the second propulsion system. The second engine third rotating structure may include a second engine third structure bladed rotor disposed within the turbine section of the second propulsion system. The second engine third structure bladed rotor may have a second system third rotor rotation parameter equal to positive one where the second engine third structure bladed rotor is configured to rotate in the first rotational direction or negative one where the second engine third structure bladed rotor is configured to rotate in the second rotational direction. An absolute value of a sum of the first propulsor rotation parameter, the second propulsor rotation parameter, the first system first rotor rotation parameter, the second system first rotor rotation parameter, the first system second rotor rotation parameter, the second system second rotor rotation parameter, the first system third rotor rotation parameter and the second system third rotor rotation parameter may be equal to or less than two.

The sum of the first propulsor rotation parameter, the second propulsor rotation parameter, the first system first rotor rotation parameter, the second system first rotor rotation parameter, the first system second rotor rotation parameter, the second system second rotor rotation parameter, the first system third rotor rotation parameter and the second system third rotor rotation parameter may be equal to zero.

The turbine engine of each of the first propulsion system and the second propulsion system may be configured as a two-spool engine.

The turbine engine of each of the first propulsion system and the second propulsion system may be configured as a three-spool engine.

Each of the first propulsion system and the second propulsion system may also include an open guide vane structure next to the open propulsor rotor.

Each of the first propulsion system and the second propulsion system may also include a geared drivetrain operatively coupling the open propulsor rotor to the turbine engine.

The assembly may also include an aircraft airframe comprising an aircraft fuselage. The first propulsion system and the second propulsion system may be mounted to the aircraft airframe and arranged to opposing lateral sides of the aircraft fuselage.

The open propulsor rotor of each of the first propulsion system and the second propulsion system may include at least twelve of the open propulsor blades.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of an aircraft with multiple propulsion systems mounted to wings of the aircraft.

FIG. 2 is a schematic illustration of the aircraft with its propulsion systems mounted to a fuselage of the aircraft.

FIG. 3 is a schematic illustration of an exemplary one of the propulsion systems.

FIG. 4 is a schematic illustration of a forward portion of the propulsion system of FIG. 3.

FIGS. 5A and 5B are front view illustrations of the aircraft depicting various symmetric propulsor rotating patterns with a propulsion system pair.

FIG. 6 is a front view illustration of an aircraft depicting an asymmetric propulsor rotating pattern.

FIG. 7 is a partial schematic illustration of a first aircraft propulsion system at a set of gear systems.

FIG. 8 is a schematic illustration of a first of the gear systems coupled with components of the first aircraft propulsion system.

FIG. 9 is a schematic illustration of a second of the gear systems coupled with components of the first aircraft propulsion system.

FIG. 10 is a partial schematic illustration of a second aircraft propulsion system at a set of gear systems.

FIG. 11 is a schematic illustration of a first of the gear systems coupled with components of the second aircraft propulsion system.

FIG. 12 is a schematic illustration of a second of the gear systems coupled with components of the second aircraft propulsion system.

FIG. 13 is a partial schematic illustration depicting assembly of the first and the second aircraft propulsion systems.

FIG. 14 is a partial schematic illustration of an exemplary one of the propulsion systems configured without a guide vane structure.

FIG. 15 is a schematic illustration of the propulsion system with an alternative turbine engine arrangement.

FIG. 16 is a schematic illustration of the propulsion system with another alternative turbine engine arrangement.

FIG. 17 is a schematic illustration of a rotor for the propulsion system.

FIGS. 18A-D are front view illustrations of the aircraft depicting various symmetric propulsor rotating patterns with multiple propulsion system pairs.

FIGS. 19 and 20 are front view illustrations of the aircraft with alternative propulsion system mounting arrangements.

FIGS. 21A-C are perspective illustrations of a blended wing body aircraft with various propulsion system mounting arrangements.

FIG. 22 is a schematic illustration of the propulsion system with an alternative geartrain arrangement.

### DETAILED DESCRIPTION

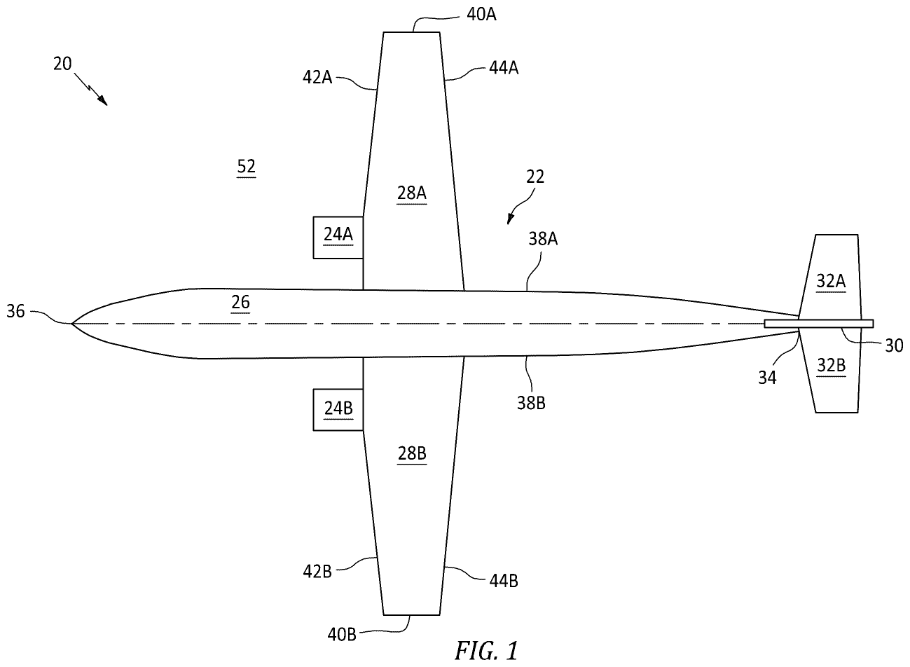

FIG. 1 is a schematic illustration of an aircraft 20. This aircraft 20 may be an airplane, a drone (e.g., an unmanned aerial vehicle (UAV)), or any other manned or unmanned aerial vehicle or system. The aircraft 20 includes an aircraft airframe 22 and one or more aircraft propulsion systems 24A and 24B (generally referred to as “24”); e.g., a pair of companion aircraft propulsion systems.

The aircraft airframe 22 of FIG. 1 includes an aircraft fuselage 26 and one or more aircraft wings 28A and 28B (generally referred to as “28”). This aircraft airframe 22 may also include one or more aircraft stabilizers, such as at least one vertical stabilizer 30 and one or more horizontal stabilizers 32A and 32B arranged at (e.g., on, adjacent or proximate) an aft, downstream tail end 34 of the aircraft fuselage 26. However, in other embodiments, it is contemplated one or more of the aircraft stabilizers may be omitted where, for example, the aircraft 20 is alternatively configured as a blended wing aircraft.

The aircraft fuselage 26 extends longitudinally along a longitudinal centerline of the aircraft airframe 22 and its aircraft fuselage 26 from a forward, upstream nose end 36 of the aircraft airframe 22 and its aircraft fuselage 26 to the fuselage tail end 34. The aircraft fuselage 26 extends laterally between and to opposing lateral sides 38A and 38B (generally referred to as “38”) of the aircraft fuselage 26.

The aircraft wings 28A and 28B are arranged to the opposing lateral sides 38A and 38B of the aircraft fuselage 26. The first aircraft wing 28A of FIG. 1, for example, is connected to the aircraft fuselage 26 at the fuselage first side 38A. The second aircraft wing 28B is connected to the aircraft fuselage 26 at the fuselage second side 38B. The aircraft fuselage 26 of FIG. 1 is thereby located laterally between the first aircraft wing 28A and the second aircraft wing 28B. Each of these aircraft wings 28A, 28B projects spanwise out from the aircraft fuselage 26 to a tip 40A, 40B of the respective aircraft wing 28A, 28B. Each of the aircraft wings 28A, 28B extends longitudinally between and to a leading edge 42A, 42B of the respective aircraft wing 28A, 28B and a trailing edge 44A, 44B of the respective aircraft wing 28A, 28B.

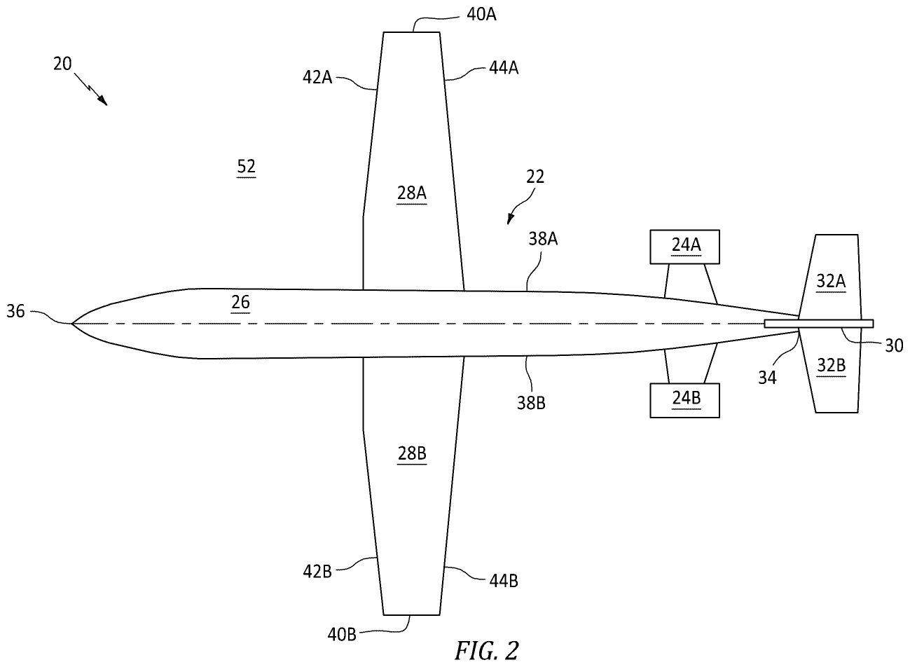

The aircraft propulsion systems 24A and 24B of FIG. 1 are arranged to the opposing lateral sides 38A and 38B of the aircraft fuselage 26. The first aircraft propulsion system 24A of FIG. 1, for example, is mounted to the first aircraft wing 28A. The second aircraft propulsion system 24B is mounted to the second aircraft wing 28B. The aircraft fuselage 26 of FIG. 1 is thereby located laterally between the first aircraft propulsion system 24A and the second aircraft propulsion system 24B. The present disclosure, however, is not limited to such an exemplary arrangement. For example, referring to FIG. 2, the first aircraft propulsion system 24A may alternatively be mounted to the aircraft fuselage 26 at the fuselage first side 38A. The second aircraft propulsion system 24B may alternatively be mounted to the aircraft fuselage 26 at the fuselage second side 38B.

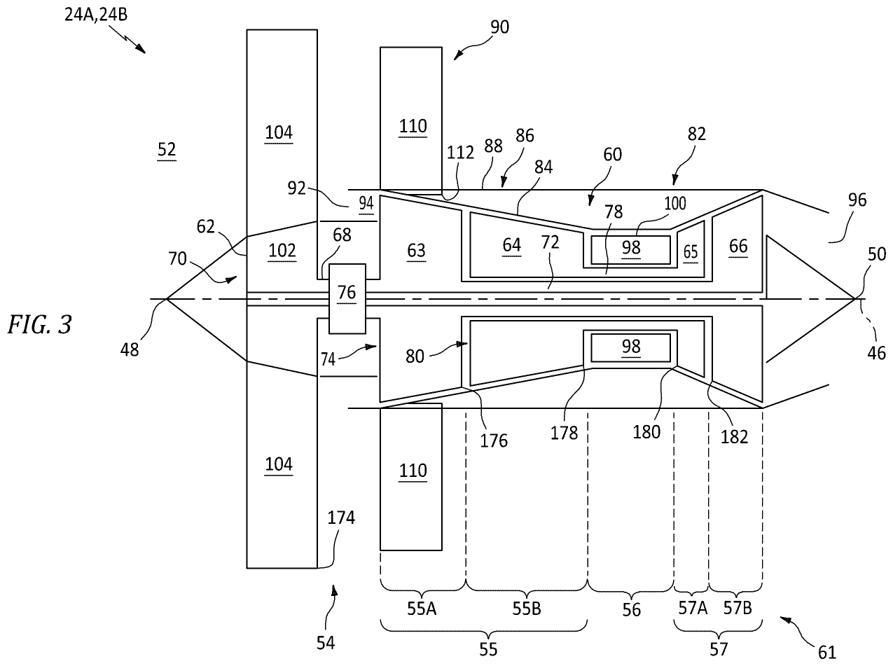

Referring to FIG. 3, each aircraft propulsion system 24A and 24B extends axially along an axis 46 between a forward, upstream end 48 of the respective aircraft propulsion system 24 and an aft, downstream end 50 of the respective aircraft propulsion system 24. The axis 46 may be a centerline axis of the respective aircraft propulsion system 24 and/or one or more of its members. The axis 46 may also or alternatively be a rotational axis of one or more members of the respective aircraft propulsion system 24.

The aircraft propulsion system 24 of FIG. 3 is configured as an open rotor propulsion system; e.g., a single rotor and swirl recovery vane (SRV) open rotor propulsion system. Here, the term “open” may describe a propulsion system section and/or a propulsion system component which is open to an environment 52 (e.g., an ambient environment) external to the respective aircraft propulsion system 24 and, more generally, the aircraft 20 (see FIGS. 1 and 2). The aircraft propulsion system 24 of FIG. 3, for example, includes an open propulsion section 54, a compressor section 55, a combustor section 56 and a turbine section 57. The compressor section 55 of FIG. 3 includes a low pressure compressor (LPC) section 55A and a high pressure compressor (HPC) section 55B. The turbine section 57 of FIG. 3 includes a high pressure turbine (HPT) section 57A and a low pressure turbine (LPT) section 57B. At least (or only) the LPC section 55A, the HPC section 55B, the combustor section 56, the HPT section 57A and the LPT section 57B collectively form an engine core 60 (e.g., a gas generator) of a gas turbine engine 61.

The propulsion section 54 includes a bladed propulsor rotor 62. The propulsor rotor 62 of FIG. 3 is configured as an open rotor (e.g., an un-ducted rotor) which projects radially into and is exposed to the external environment 52. The LPC section 55A includes a low pressure compressor (LPC) rotor 63. The HPC section 55B includes a high pressure compressor (HPC) rotor 64. The HPT section 57A includes a high pressure turbine (HPT) rotor 65. The LPT section 57B includes a low pressure turbine (LPT) rotor 66. Each of the bladed rotors 63-66 of FIG. 3 is configured as a ducted rotor internal within the respective aircraft propulsion system 24 and outside of the external environment 52.

The propulsor rotor 62 of FIG. 3 is connected to a propulsor shaft 68. At least (or only) the propulsor rotor 62 and the propulsor shaft 68 collectively form a propulsor rotating structure 70. This propulsor rotating structure 70 of FIG. 3 and its members 62 and 68 are rotatable about the axis 46 of the respective aircraft propulsion system 24.

The LPC rotor 63 is coupled to and rotatable with the LPT rotor 66. The LPC rotor 63 of FIG. 3, for example, is connected to the LPT rotor 66 through a low speed shaft 72. At least (or only) the LPC rotor 63, the LPT rotor 66 and the low speed shaft 72 collectively form a low speed rotating structure 74; e.g., a low speed spool of the engine core 60. This low speed rotating structure 74 of FIG. 3 and its members 63, 66 and 72 are rotatable about the axis 46 of the respective aircraft propulsion system 24. However, in other embodiments, the low speed rotating structure 74 and its members 63, 66 and 72 may alternatively be rotatable about another rotational axis which is (e.g., radially and/or angularly) offset from the rotational axis of the propulsor rotor 62.

The low speed rotating structure 74 is coupled to the propulsor rotating structure 70. The low speed rotating structure 74 of FIG. 3, for example, is connected to the propulsor rotating structure 70 through a geartrain 76. With this arrangement, the low speed rotating structure 74 and its LPT rotor 66 may rotate at a different (e.g., faster) rotational velocity than the propulsor rotating structure 70 and its propulsor rotor 62. Depending on the specific configuration of the geartrain 76, the propulsor rotor 62 and the low speed rotating structure 74 may rotate in a common (the same) direction about the axis 46 or in opposite directions about the axis 46. While the aircraft propulsion system 24 is described above with a geared drivetrain operatively coupling the low speed rotating structure 74 to the propulsor rotating structure 70 and its propulsor rotor 62, the present disclosure is not limited to such an exemplary configuration. For example, the aircraft propulsion system 24 may alternatively include a direct-drive drivetrain operatively coupling the low speed rotating structure 74 to the propulsor rotor 62. With such an arrangement, the propulsor rotor 62 and the low speed rotating structure 74 and its LPT rotor 66 may rotate at a common rotational speed and in a common direction about the axis 46.

The HPC rotor 64 is coupled to and rotatable with the HPT rotor 65. The HPC rotor 64 of FIG. 3, for example, is connected to the HPT rotor 65 through a high speed shaft 78. At least (or only) the HPC rotor 64, the HPT rotor 65 and the high speed shaft 78 collectively form a high speed rotating structure 80; e.g., a high speed spool of the engine core 60. This high speed rotating structure 80 of FIG. 3 and its members 64, 65 and 78 are rotatable about the axis 46 of the respective aircraft propulsion system 24. However, in other embodiments, the high speed rotating structure 80 and its members 64, 65 and 78 may alternatively be rotatable about another rotational axis which is (e.g., radially and/or angularly) offset from the rotational axis of the propulsor rotor 62.

The engine sections 55A-57B may be arranged sequentially along the axis 46 of the respective aircraft propulsion system 24 and are housed within a stationary housing 82 of the respective aircraft propulsion system 24. This propulsion system housing 82 includes a core case 84 (e.g., a gas generator case) and a nacelle 86. The core case 84 houses one or more of the propulsion system sections 55A-57B; e.g., the engine core 60. The core case 84 of FIG. 3, for example, extends axially along (e.g., axially overlaps) and extends circumferentially about (e.g., circumscribes) the engine sections 55A-57B and their respective bladed rotors 63-66. The core case 84 may also house the geartrain 76. The nacelle 86 houses and provides an aerodynamic cover over the core case 84. An exterior wall 88 of the nacelle 86 of FIG. 3, for example, is disposed radially outboard of, extends axially along (e.g., axially overlaps) and extends circumferentially about (e.g., circumscribes) the engine core 60 and its core case 84. With this arrangement, the bladed rotors 63-66 are disposed within the propulsion system housing 82. The propulsor rotor 62 is disposed at least partially (or completely) outside of the propulsion system housing 82.

During operation of the respective aircraft propulsion system 24, ambient air within the external environment 52 is propelled by the propulsor rotor 62 in an aft, downstream direction towards the propulsion system downstream end 50. A major portion (e.g., more than 50%) of this air bypasses the engine core 60 to provide forward thrust while a minor portion (e.g., less than 50%) of the air flows into the engine core 60. An outer stream of the air propelled by the propulsor rotor 62, for example, flows axially across a guide vane structure 90 of the propulsion section 54 and outside of the propulsion system housing 82 (along the nacelle wall 88). The guide vane structure 90 is configured to condition (e.g., straighten out) the air propelled by the propulsor rotor 62, for example, to remove or reduce circumferential swirl and thereby enhance the forward thrust. An inner stream of the air propelled by the propulsor rotor 62 flows through an airflow inlet 92 of a core flowpath 94 into the aircraft propulsion system 24 and its engine core 60. The core flowpath 94 extends sequentially through the LPC section 55A, the HPC section 55B, the combustor section 56, the HPT section 57A and the LPT section 57B from the core inlet 92 to a combustion products exhaust 96 from the core flowpath 94 into the external environment 52. The air entering the core flowpath 94 may be referred to as “core air”.

The core air is compressed by the LPC rotor 63 and the HPC rotor 64 and directed into a combustion chamber 98 (e.g., an annular combustion chamber) of a combustor 100 (e.g., an annular combustor) in the combustor section 56. Fuel is injected into the combustion chamber 98 by one or more fuel injectors and mixed with the compressed core air to provide a fuel-air mixture. This fuel-air mixture is ignited and combustion products thereof flow through and sequentially drive rotation of the HPT rotor 65 and the LPT rotor 66. The rotation of the HPT rotor 65 and the LPT rotor 66 respectively drive rotation of the HPC rotor 64 and the LPC rotor 63 and, thus, compression of the air received from the core inlet 92. The rotation of the LPT rotor 66 also drives rotation of the propulsor rotor 62 through the geartrain 76. The rotation of the propulsor rotor 62, in turn, propels the ambient air within the external environment 52 in the aft, downstream direction. With this arrangement, the engine core 60 powers operation of (e.g., drives rotation of) the propulsor rotor 62 during aircraft propulsion system operation.

The propulsor rotor 62 of FIG. 3 includes a propulsor rotor base 102 (e.g., a disk or a hub) and a plurality of open propulsor blades 104 (e.g., airfoils). The propulsor blades 104 are arranged circumferentially about the rotor base 102 and the axis 46 of the respective aircraft propulsion system 24 in an array; e.g., a circular array. This array of the propulsor blades 104 may be unshrouded or alternatively shrouded by a tubular propulsor rotor shroud dedicated to the propulsor rotor 62 for example. The propulsor blade array and, more generally, the propulsor rotor 62 may include a total number of nine (9) or more (e.g., twelve (12) or more) of the propulsor blades 104. Each of the propulsor blades 104 is connected to (e.g., formed integral with or otherwise attached to) the rotor base 102.

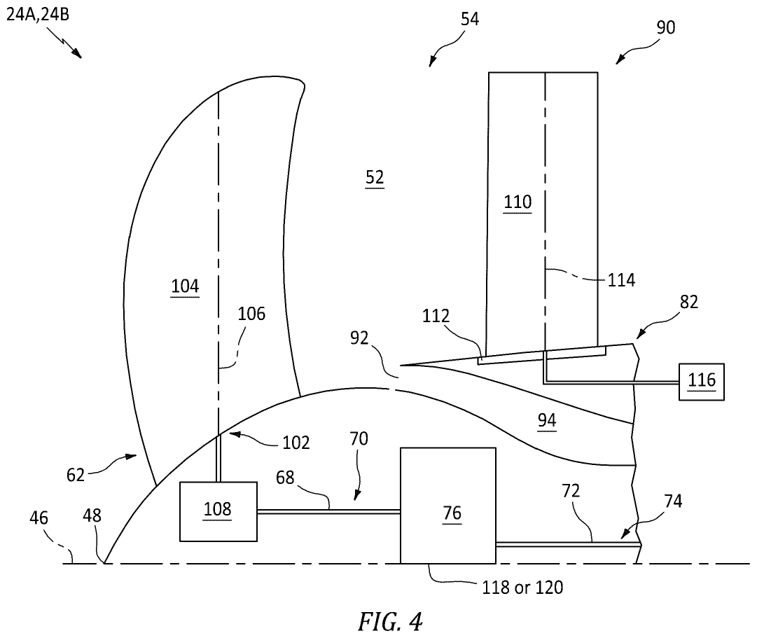

Referring to FIG. 4, each of the propulsor blades 104 projects spanwise along a span line of the respective propulsor blade 104 (e.g., radially relative to the respective axis 46) out from an exterior surface of the rotor base 102, into the external environment 52, to an unshrouded, distal tip of the respective propulsor blade 104. Here, the exterior surface radially borders the external environment 52 and forms an inner platform surface of the propulsor rotor 62. Each propulsor blade 104 is thereby configured as an un-ducted and unshrouded (or alternatively shrouded) propulsor blade which is exposed to (e.g., disposed in) the surrounding external environment 52.

Each propulsor blade 104 may be configured to pivot about a respective pivot axis 106. This blade pivot axis 106 extends radially relative to the axis 46 of the respective aircraft propulsion system 24. The blade pivot axis 106 of FIG. 4, for example, is arranged perpendicular to the respective axis 46 when viewed, for example, in a longitudinal reference plane parallel with (e.g., including) the respective axis 46; e.g., plane of FIG. 4. Each propulsor blade 104 of FIG. 4 is operatively coupled with a blade actuation system 108. This blade actuation system 108 is configured to pivot each propulsor blade 104 about its respective blade pivot axis 106. By pivoting the respective propulsor blade 104 about the respective blade pivot axis 106, a pitch of the respective propulsor blade 104 may be changed. Note, while the blade pivot axis 106 is shown as being perpendicular to the respective axis 46 in FIG. 4, it is contemplated this blade pivot axis 106 may or may not be coincident with the respective axis 46. Moreover, it is contemplated each blade pivot axis 106 may alternatively be angularly offset from the respective axis 46 by an acute angle or an obtuse angle when viewed, for example, in the longitudinal reference plane. Of course, in other embodiments, it is contemplated some or all of the propulsor blades 104 may be alternatively moved to change the propulsor blade pitch and/or another propulsor blade parameter such as blade camber. In still other embodiments, it is contemplated some or all of the propulsor blades 104 may alternatively be configured as fixed position (e.g., non-moving) propulsor blades.

The guide vane structure 90 of FIG. 3 includes a plurality of open exit guide vanes 110 (e.g., airfoils) arranged circumferentially about the axis 46 of the respective aircraft propulsion system 24 in an array; e.g., a circular array. This array of the guide vanes 110 may be unshrouded or alternatively shrouded by a tubular guide vane shroud dedicated to the guide vane structure 90 for example. The guide vane structure 90 and its guide vanes 110 are arranged axially next to (e.g., adjacent) the propulsor rotor 62 and its propulsor blades 104. The guide vane structure 90 and its guide vanes 110 of FIG. 3, for example, are arranged downstream of the propulsor rotor 62 and its propulsor blades 104, without (e.g., any) other elements axially therebetween to obstruct, turn and/or otherwise influence the air propelled by the propulsor rotor 62 to the guide vane structure 90 for example. Each of the guide vanes 110 of FIG. 3 is coupled to a support structure 112 of the propulsion system housing 82. This support structure 112 may be a support frame, a case or another fixed structure of the propulsion system housing 82.

Referring to FIG. 4, each of the guide vanes 110 projects spanwise along a span line of the respective guide vane 110 (e.g., radially relative to the respective axis 46) out from an exterior surface of the propulsion system housing 82, into the external environment 52, to an unshrouded, distal tip of the respective guide vane 110. Each guide vane 110 is thereby configured as an un-ducted and unshrouded (or alternatively shrouded) guide vane which is exposed to (e.g., disposed in) the surrounding external environment 52.

Each guide vane 110 may be configured to pivot about a respective pivot axis 114. This vane pivot axis 114 extends radially relative to the axis 46 of the respective aircraft propulsion system 24. The vane pivot axis 114 of FIG. 4, for example, is arranged perpendicular to the respective axis 46 when viewed, for example, in the longitudinal reference plane. Each guide vane 110 of FIG. 4 is operatively coupled with a vane actuation system 116. This vane actuation system 116 is configured to pivot each guide vane 110 about its respective vane pivot axis 114. This vane actuation system 116 may be discrete from or integrated as part of the blade actuation system 108. By pivoting the respective guide vane 110 about the respective vane pivot axis 114, a pitch of the respective guide vane 110 may be changed. Note, while the vane pivot axis 114 is shown as being perpendicular to the respective axis 46 in FIG. 4, it is contemplated this vane pivot axis 114 may or may not be coincident with the respective axis 46. Moreover, it is contemplated each vane pivot axis 114 may alternatively be angularly offset from the respective axis 46 by an acute angle or an obtuse angle when viewed, for example, in the longitudinal reference plane. Of course, in other embodiments, it is contemplated some or all of the guide vanes 110 may be alternatively moved to change the guide vane pitch and/or another guide vane parameter such as vane camber. In still other embodiments, it is contemplated some or all of the guide vanes 110 may alternatively be configured as fixed position (e.g., non-moving) guide vanes 110.

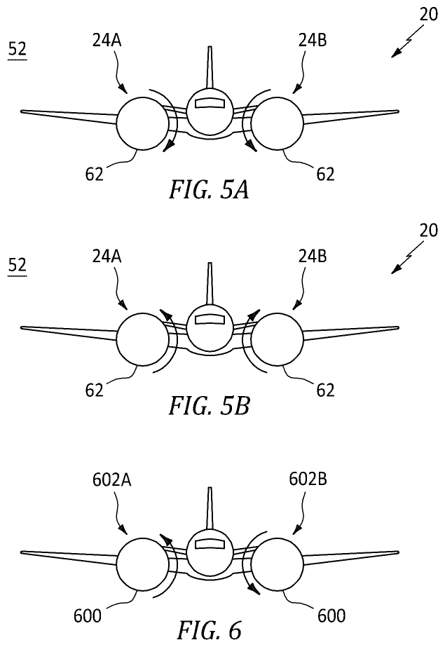

The first aircraft propulsion system 24A is configured such that its propulsor rotor 62 rotates in a first rotational direction (e.g., clockwise or counterclockwise) about the respective axis 46 when viewed in a lateral reference plane perpendicular to the respective axis 46 (e.g., see plane of FIGS. 5A and 5B). By contrast, the second aircraft propulsion system 24B is configured such that its propulsor rotor 62 rotates in a second rotational direction (e.g., counterclockwise or clockwise) about the respective axis 46 when viewed in the lateral reference plane. This second rotational direction is rotationally opposite the first rotational direction. Referring to FIGS. 5A and 5B, the propulsor rotor 62 of the first aircraft propulsion system 24A and the propulsor rotor 62 of the second aircraft propulsion system 24B thereby rotate in different rotational directions during aircraft flight. In FIG. 5A, the propulsor rotors 62 of the aircraft propulsion systems 24A and 24B rotate in an inboard down-down symmetric rotating pattern, for example when viewed in the lateral reference plane. In FIG. 5B, the propulsor rotors 62 of the aircraft propulsion systems 24A and 24B rotate in an inboard up-up symmetric rotating pattern, for example when viewed in the lateral reference plane. Such symmetric rotating patterns may facilitate a reduction in propulsion system noise, an increase in propulsion system performance, provision of symmetric control surface geometries, etc. By contrast, FIG. 6 illustrates propulsor rotors 600 of right and left side aircraft propulsion systems 602A and 602B rotating in an asymmetric rotating pattern, for example when viewed in the lateral reference plane.

In some embodiments, referring to FIG. 3, the aircraft propulsion systems 24A and 24B may be configured with different (e.g., uniquely configured, opposite rotation, etc.) turbine engines 61 to facilitate the symmetric rotating pattern of FIG. 5A or 5B in the aircraft propulsion systems 24A and 24B. For example, where each geartrain 76 is configured such that the rotating components 62 and 74 coupled therewith rotate in a common rotational direction, (a) the low speed rotating structure 74 of the first aircraft propulsion system 24A may be configured to rotate in the first rotational direction and (b) the low speed rotating structure 74 of the second aircraft propulsion system 24B may be configured to rotate in the second rotational direction. In another example, where each geartrain 76 is configured such that the rotating components 62 and 74 coupled therewith rotate in opposite rotational directions, (a) the low speed rotating structure 74 of the first aircraft propulsion system 24A may be configured to rotate in the second rotational direction and (b) the low speed rotating structure 74 of the second aircraft propulsion system 24B may be configured to rotate in the first rotational direction. While such embodiments have various benefits, these embodiments may also lead to duplication of research and development efforts for the two different turbine engines 61 and engine cores 60. Moreover, to maintain a supply of spare parts, two separate supplies of spare parts may need to be maintained, one for each turbine engine/engine core configuration.

In some embodiments, the aircraft propulsion systems 24A and 24B may be configured with different (e.g., uniquely configured) drivetrains operatively coupling the turbine engines 61 to the propulsor rotors 62. For example, the geartrain 76 of the first aircraft propulsion systems 24A may be configured as a counter-rotating geartrain; e.g., a geartrain configured as or otherwise including an epicyclic star gear system. The low speed rotating structure 74 of the first aircraft propulsion system 24A may thereby be configured to rotate in the second rotational direction to facilitate rotation of the associated propulsor rotor 62 in the first rotational direction. By contrast, the geartrain 76 of the second aircraft propulsion systems 24B may be configured as a co-rotating geartrain; e.g., a geartrain configured as or otherwise including an epicyclic planetary gear system. The low speed rotating structure 74 of the second aircraft propulsion system 24B may thereby be configured to rotate in the second rotational direction to facilitate rotation of the associated propulsor rotor 62 in the second rotational direction. In another example, the geartrain 76 of the first aircraft propulsion systems 24A may be configured as a co-rotating geartrain. The low speed rotating structure 74 of the first aircraft propulsion system 24A may thereby be configured to rotate in the first rotational direction to facilitate rotation of the associated propulsor rotor 62 in the first rotational direction. By contrast, the geartrain 76 of the second aircraft propulsion systems 24B may be configured as a counter-rotating geartrain. The low speed rotating structure 74 of the second aircraft propulsion system 24B may thereby be configured to rotate in the first rotational direction to facilitate rotation of the associated propulsor rotor 62 in the second rotational direction. With such embodiments, the aircraft propulsion systems 24A and 24B may share a common turbine engine configuration, a common engine core configuration, or at least one or more common internal core components and/or structures; e.g., the rotating structure(s) 74, 80, the combustor 100, etc. Herein, the term “common” may describe elements which are identical and may share a single manufacturer/supplier part number. Spare parts for the first and second aircraft propulsion systems 24A and 24B may thereby be significantly reduced because a single replacement turbine engine 61, a single replacement engine core 60 and/or a single set of parts may be used with either the first aircraft propulsion system 24A or the second aircraft propulsion system 24B.

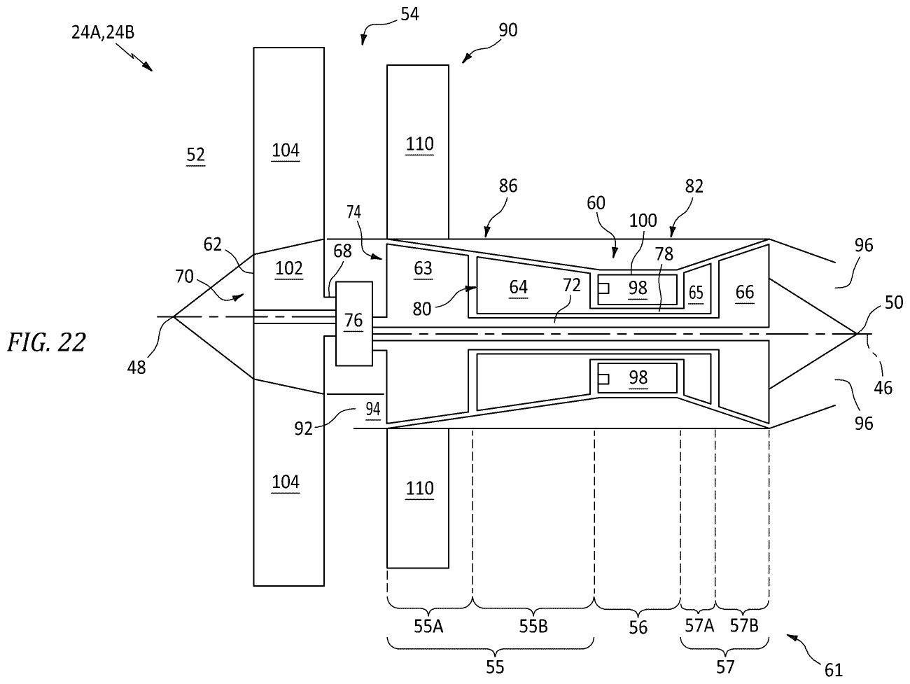

Each geartrain 76 of FIGS. 3 and 4 is generally described above with a single gear system (e.g., a single epicyclic gear system) operatively coupling the low speed rotating structure 74 to the propulsor rotor 62. A centerline of each geartrain 76 is also shown in FIGS. 3 and 4 as being coaxial with both the low speed rotating structure 74 and the propulsor rotor 62 such that those rotating components 74 and 62 share a common rotational axis; e.g., the axis 46. The present disclosure, however, is not limited to such exemplary geartrain arrangements. For example, the geartrain 76 of the first aircraft propulsion systems 24A and/or the second aircraft propulsion systems 24B may alternatively include multiple gear systems (e.g., a serial stack of epicyclic gear systems) operatively coupling the low speed rotating structure 74 to the propulsor rotor 62, various embodiments of which are described below in further detail. In another example, referring to FIG. 22, the geartrain 76 of first aircraft propulsion systems 24A and/or second aircraft propulsion systems 24B may also or alternatively be configured as an offset geartrain such that the rotational axis of the low speed rotating structure 74 is offset (e.g., radially and/or angularly offset) from the rotational axis of the propulsor rotor 62.

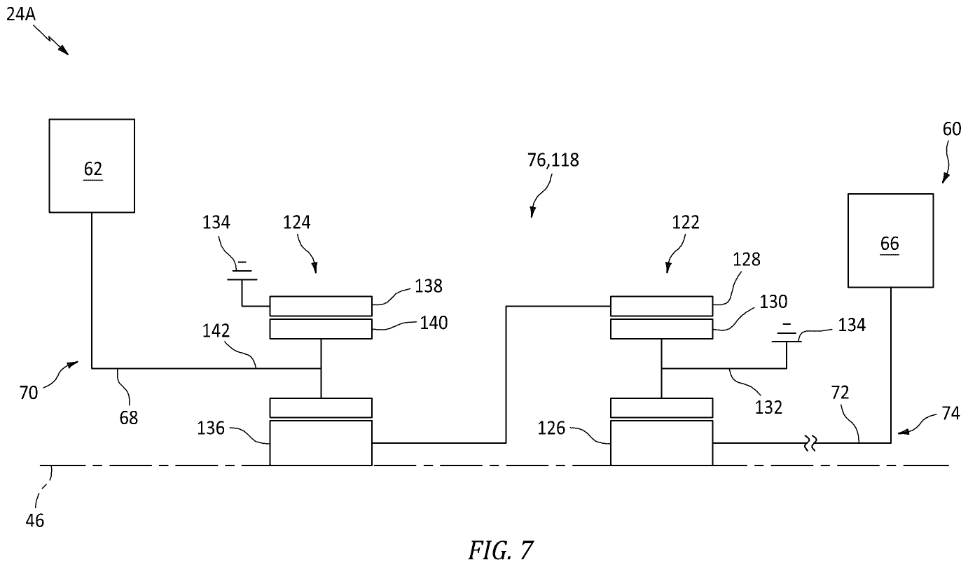

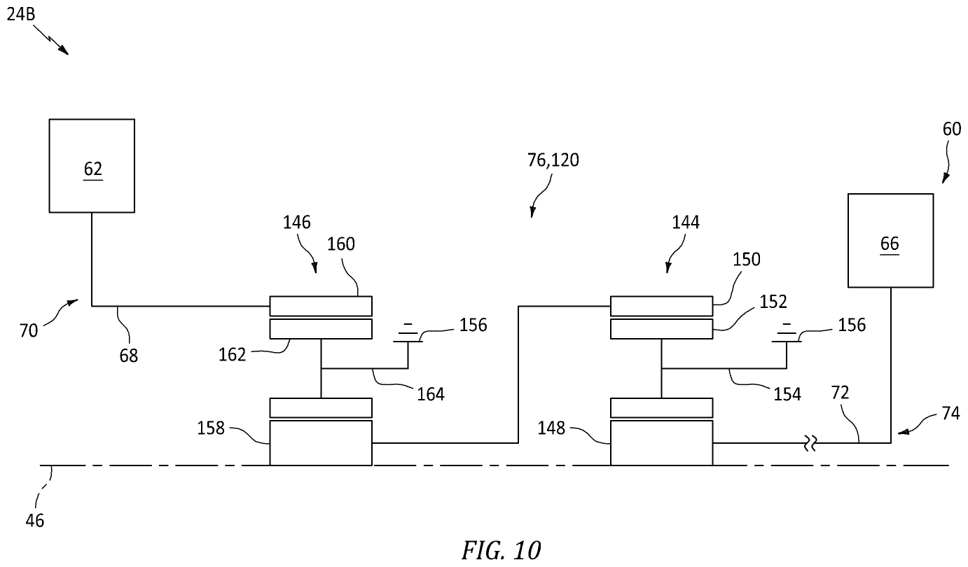

In some embodiments, the aircraft propulsion systems 24A and 24B may be provided with different geartrain configurations to facilitate the symmetric rotating patterns as described above. The geartrain 76 of the first aircraft propulsion system 24A of FIG. 4, for example, may be configured as or otherwise include a counter-rotating geartrain 118 (FIG. 7). By contrast, the geartrain 76 of the second aircraft propulsion system 24B may be configured as or otherwise include a co-rotating geartrain 120 (FIG. 10). Of course, it is contemplated the rotating patterns of the first aircraft propulsion system 24A and the second aircraft propulsion system 24B may be reversed in other embodiments. The geartrain 76 of the first aircraft propulsion system 24A of FIG. 4, for example, may be configured as or otherwise include the co-rotating geartrain 120 (FIG. 10). The geartrain 76 of the second aircraft propulsion system 24B may be configured as or otherwise include the counter-rotating geartrain 118 (FIG. 7).

Referring to FIG. 7, the counter-rotating geartrain 118 may be configured with one or more internal gear systems; e.g., epicyclic gear systems. The counter-rotating geartrain 118 of FIG. 7, for example, includes an input star gear system 122 and an output planetary gear system 124. Here, the input star gear system 122 operatively couples the low speed rotating structure 74 of the first aircraft propulsion system 24A to the output planetary gear system 124. The output planetary gear system 124 operatively couples the input star gear system 122 to the propulsor rotating structure 70 of the first aircraft propulsion system 24A.

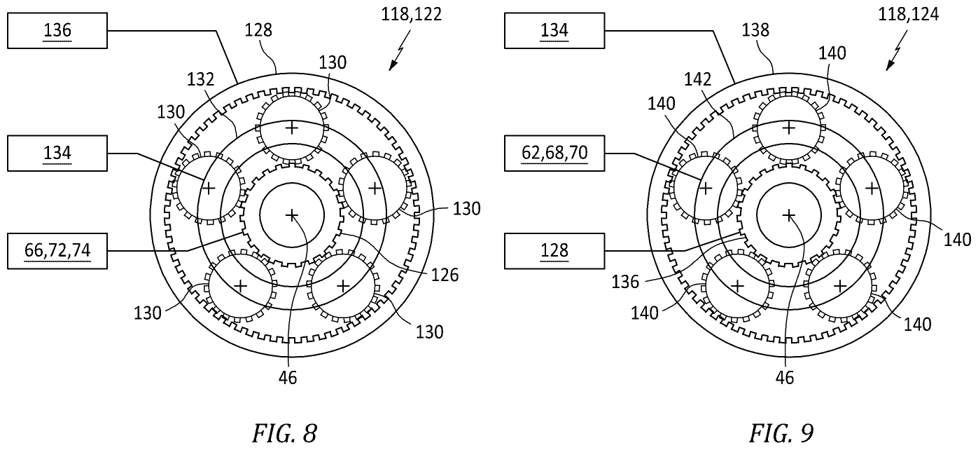

Referring to FIG. 8, the input star gear system 122 includes a first sun gear 126, a first ring gear 128, a plurality of first intermediate gears 130 (e.g., star gears) and a stationary first carrier 132. Referring to FIG. 7, the first sun gear 126 is rotatable about the axis 46 of the first aircraft propulsion system 24A. The first sun gear 126 is coupled to and rotatable with the low speed rotating structure 74 and its low speed shaft 72 of the first aircraft propulsion system 24A. The low speed rotating structure 74 of the first aircraft propulsion system 24A is thereby operatively coupled to the counter-rotating geartrain 118 and its input star gear system 122 through the first sun gear 126. The first ring gear 128 circumscribes the first sun gear 126 and the first intermediate gears 130. The first ring gear 128 is rotatable about the axis 46 of the first aircraft propulsion system 24A. The first intermediate gears 130 are arranged circumferentially about the axis 46 of the first aircraft propulsion system 24A and the first sun gear 126 in an array. Each of the first intermediate gears 130 is disposed radially between and meshed with the first sun gear 126 and the first ring gear 128. Each of the first intermediate gears 130 is rotatably mounted to the first carrier 132. The first carrier 132 of FIG. 8 is fixedly connected to a stationary structure 134 of the first aircraft propulsion system 24A.

Referring to FIG. 9, the output planetary gear system 124 includes a second sun gear 136, a stationary second ring gear 138, a plurality of second intermediate gears 140 (e.g., planet gears) and a second carrier 142. Referring to FIG. 7, the second sun gear 136 is rotatable about the axis 46 of the first aircraft propulsion system 24A. The second sun gear 136 is coupled to and rotatable with the first ring gear 128. The first ring gear 128 is thereby operatively coupled to the output planetary gear system 124 through the second sun gear 136. The second ring gear 138 circumscribes the second sun gear 136 and the second intermediate gears 140. The second ring gear 138 of FIG. 9 is fixedly connected to the stationary structure 134 of the first aircraft propulsion system 24A. The second intermediate gears 140 are arranged circumferentially about the axis 46 of the first aircraft propulsion system 24A and the second sun gear 136 in an array. Each of the second intermediate gears 140 is disposed radially between and meshed with the second sun gear 136 and the second ring gear 138. Each of the second intermediate gears 140 is rotatably mounted to the second carrier 142. The second carrier 142 is rotatable about the axis 46 of the first aircraft propulsion system 24A. The second carrier 142 is coupled to and rotatable with the propulsor rotating structure 70 and its propulsor shaft 68 of the first aircraft propulsion system 24A. The propulsor rotating structure 70 of the first aircraft propulsion system 24A is thereby operatively coupled to the counter-rotating geartrain 118 and its output planetary gear system 124 through the second carrier 142.

Referring to FIG. 10, the co-rotating geartrain 120 may be configured with one or more internal gear systems; e.g., epicyclic gear systems. The co-rotating geartrain 120 of FIG. 10, for example, includes an input star gear system 144 and an output star gear system 146. Here, the input star gear system 144 operatively couples the low speed rotating structure 74 of the second aircraft propulsion system 24B to the output star gear system 146. The output star gear system 146 operatively couples the input star gear system 144 to the propulsor rotating structure 70 of the second aircraft propulsion system 24B.

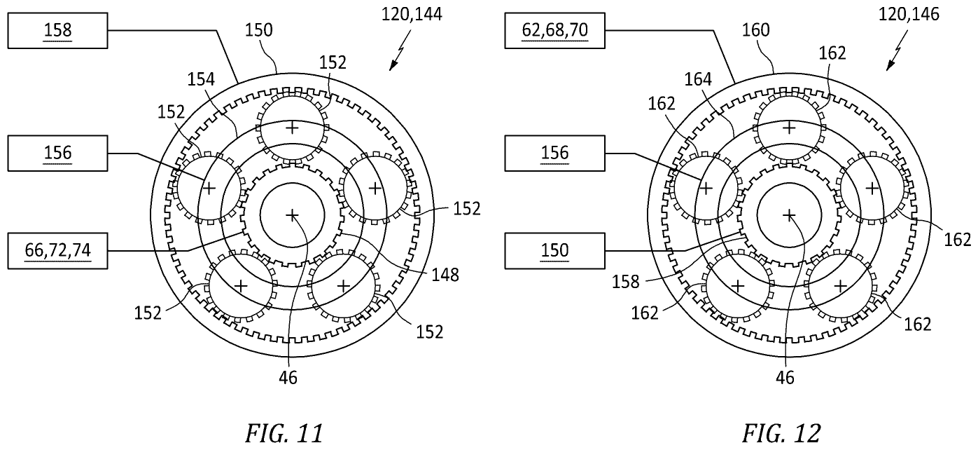

Referring to FIG. 11, the input star gear system 144 includes a first sun gear 148, a first ring gear 150, a plurality of first intermediate gears 152 (e.g., star gears) and a stationary first carrier 154. Referring to FIG. 10, the first sun gear 148 is rotatable about the axis 46 of the second aircraft propulsion system 24B. The first sun gear 148 is coupled to and rotatable with the low speed rotating structure 74 and its low speed shaft 72 of the second aircraft propulsion system 24B. The low speed rotating structure 74 of the second aircraft propulsion system 24B is thereby operatively coupled to the co-rotating geartrain 120 and its input star gear system 144 through the first sun gear 148. The first ring gear 150 circumscribes the first sun gear 148 and the first intermediate gears 152. The first ring gear 150 is rotatable about the axis 46 of the second aircraft propulsion system 24B. The first intermediate gears 152 are arranged circumferentially about the axis 46 of the second aircraft propulsion system 24B and the first sun gear 148 in an array. Each of the first intermediate gears 152 is disposed radially between and meshed with the first sun gear 148 and the first ring gear 150. Each of the first intermediate gears 152 is rotatably mounted to the first carrier 154. The first carrier 154 of FIG. 11 is fixedly connected to a stationary structure 156 of the second aircraft propulsion system 24B.

Referring to FIG. 12, the output star gear system 146 includes a second sun gear 158, a second ring gear 160, a plurality of second intermediate gears 162 (e.g., star gears) and a stationary second carrier 164. Referring to FIG. 10, the second sun gear 158 is rotatable about the axis 46 of the second aircraft propulsion system 24B. The second sun gear 158 is coupled to and rotatable with the first ring gear 150. The first ring gear 150 is thereby operatively coupled to the output star gear system 146 through the second sun gear 158. The second ring gear 160 circumscribes the second sun gear 158 and the second intermediate gears 162. The second ring gear 160 is rotatable about the axis 46 of the second aircraft propulsion system 24B. The second ring gear 160 is coupled to and rotatable with the propulsor rotating structure 70 and its propulsor shaft 68 of the second aircraft propulsion system 24B. The propulsor rotating structure 70 of the second aircraft propulsion system 24B is thereby operatively coupled to the co-rotating geartrain 120 and its output star gear system 146 through the second ring gear 160. The second intermediate gears 162 are arranged circumferentially about the axis 46 of the second aircraft propulsion system 24B and the second sun gear 158 in an array. Each of the second intermediate gears 162 is disposed radially between and meshed with the second sun gear 158 and the second ring gear 160. Each of the second intermediate gears 162 is rotatably mounted to the second carrier 164. The second carrier 164 of FIG. 12 is fixedly connected to the stationary structure 156 of the second aircraft propulsion system 24B.

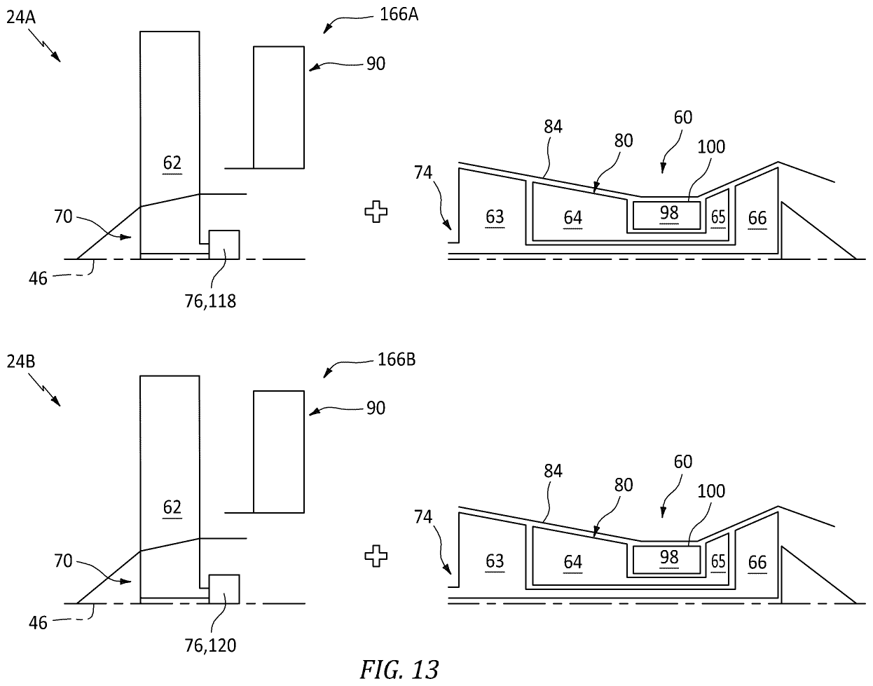

In some embodiments, referring to FIG. 13, each of the aircraft propulsion systems 24A, 24B may be configured with a unique propulsor module 166A, 166B (generally referred to as “166”). This propulsor module 166A, 166B may include the respective propulsor rotating structure 70 and the respective geartrain 118, 120. The propulsor module 166 may (or may not) also include the guide vane structure 90. However, the aircraft propulsion systems 24 may include common engine cores 60 or at least one or more common internal core components and/or structures; e.g., the rotating structure(s) 74, 80, the combustor 100, etc. Herein, the term “common” may describe elements which are identical and may share a single manufacturer/supplier part number. With such an arrangement, each aircraft propulsion system 24 may be assembled by mating and mounting its unique propulsor module 166 to the common engine core 60. Spare parts for the companion first and second aircraft propulsion systems 24A and 24B may thereby be significantly reduced because a single replacement engine core 60 and/or set a parts may be used with either the first aircraft propulsion system 24A or the second aircraft propulsion system 24B. Of course, it is contemplated the propulsor modules 166A and 166B may also include one or more common components; e.g., the actuation system(s) 108 and/or 116 of FIG. 4.

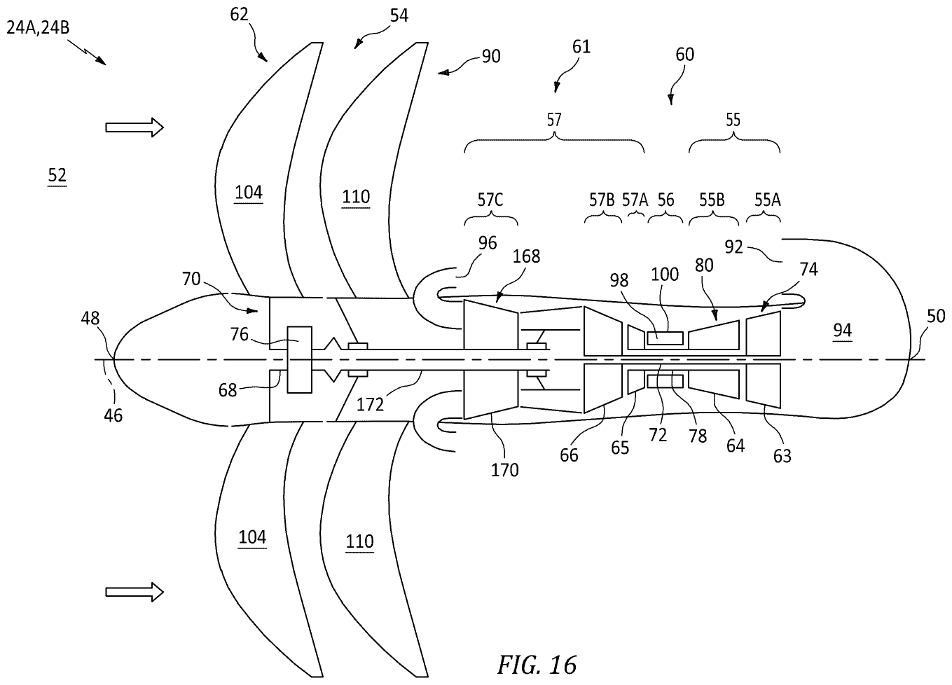

The core flowpath 94 of FIG. 3 extends longitudinally from the core inlet 92, sequentially through an inlet section, the LPC section 55A, the HPC section 55B, the combustor section 56, the HPT section 57A, the LPT section 57B and an exhaust section, to the core exhaust 96. The core flowpath 94 of FIG. 3 is configured such that the core air and the combustion products generally flow in the aft, downstream direction towards the propulsion system aft end 50. The core air and the combustion products thereby flow along with the ambient air propelled by the rotating propulsor rotor 62 in a common axial direction-the downstream, aft direction. The turbine engine 61 of the present disclosure, however, is not limited to such an exemplary common flow engine arrangement. For example, the core flowpath 94 may alternatively be configured such that the core air and the combustion products generally flow in a forward, upstream direction towards the propulsion system forward end 48. The core air and the combustion products may thereby flow in an opposite direction as the ambient air propelled by the rotating propulsor rotor 62. Here, the turbine engine 61 may have a reverse flow engine arrangement (e.g., see FIG. 16).

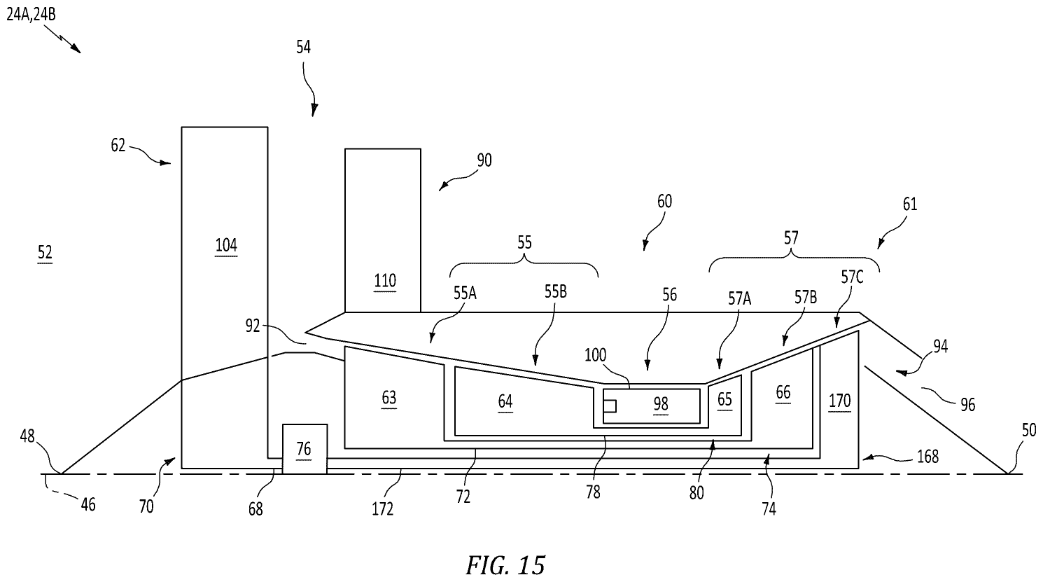

The turbine engine 61 of FIG. 3 is generally described above as a two-spool engine. For example, the turbine engine 61 is shown in FIG. 3 as including the high speed rotating structure 80 and the low speed rotating structure 74 as the (e.g., only) spool-type rotating structures in the engine core 60. The present disclosure, however, is not limited to such an exemplary arrangement. For example, referring to FIGS. 15 and 16, the low speed rotating structure 74 may be configured rotationally independent of the propulsor rotor 62. For example, the turbine engine 61 of FIGS. 15 and 16 includes an additional (e.g., a third) rotating structure—a power turbine rotating structure 168. This power turbine rotating structure 168 includes a bladed power turbine (PT) rotor 170 and a power turbine shaft 172 connected to and rotatable with the PT rotor 170. The PT rotor 170 is arranged in a power turbine (PT) section 57C of the turbine section 57, which PT section 57C is located along the core flowpath 94 between the turbine section 57B and the exhaust section. The turbine section 57B may thereby be configured as a low pressure turbine section of the engine core 60 and an intermediate pressure turbine section of the turbine engine 61. However, for ease of description, the turbine section 57B of FIGS. 15 and 16 is still referred to below as the LPT section. The geartrain 76 of FIGS. 15 and 16 operatively couples the power turbine rotating structure 168 and its PT rotor 170 to the propulsor rotating structure 70 and its propulsor rotor 62. Of course, in other embodiments, it is contemplated the geartrain 76 of FIGS. 15 and 16 may be omitted such that the drivetrain operatively coupling the power turbine rotating structure 168 to the propulsor rotor 62 is a direct-drive drivetrain.

In some embodiments, referring still to FIGS. 15 and 16, the aircraft propulsion systems 24A and 24B may be configured with different (e.g., uniquely configured, opposite rotation, etc.) PT sections 57C to facilitate the symmetric rotating pattern of FIG. 5A or 5B in the aircraft propulsion systems 24A and 24B. For example, where each geartrain 76 is configured such that the rotating components 70 and 168 coupled therewith rotate in a common rotational direction, (a) the power turbine rotating structure 168 of the first aircraft propulsion system 24A may be configured to rotate in the first rotational direction and (b) the power turbine rotating structure 168 of the second aircraft propulsion system 24B may be configured to rotate in the second rotational direction. In another example, where each geartrain 76 is configured such that the rotating components 70 and 168 coupled therewith rotate in opposite rotational directions, (a) the power turbine rotating structure 168 of the first aircraft propulsion system 24A may be configured to rotate in the second rotational direction and (b) the power turbine rotating structure 168 of the second aircraft propulsion system 24B may be configured to rotate in the first rotational direction. With such embodiments, while the PT sections 57C of the turbine engines 61 are unique to the aircraft propulsion systems 24A and 24B, the aircraft propulsion systems 24A and 24B may be configured with common engine cores 60, common geartrains 76, as well as various other common components. Spare parts for the first and second aircraft propulsion systems 24A and 24B may thereby be significantly reduced because a single replacement engine core 60 and/or a single set of other parts may be used with either the first aircraft propulsion system 24A or the second aircraft propulsion system 24B.

As described above, the aircraft propulsion systems 24A and 24B may have various configurations to facilitate the symmetric rotating pattern of FIG. 5A or 5B in the aircraft propulsion systems 24A and 24B. In some embodiments, the rotating structure (e.g., 74 in FIG. 3; 168 in FIGS. 15 and 16) coupled to the propulsor rotor 62 may rotate with the propulsor rotor 62 in a common rotational direction. In some embodiments, the rotating structure (e.g., 74 in FIG. 3; 168 in FIGS. 15 and 16) coupled to the propulsor rotor 62 may rotate with the propulsor rotor 62 in opposite rotational directions. In some embodiments, the rotating structure (e.g., 74 in FIG. 3; 168 in FIGS. 15 and 16) coupled to the propulsor rotor 62 may rotate with one or more of the core rotating structure(s) (e.g., 80 in FIG. 3; 80 and/or 74 in FIGS. 15 and 16) in a common rotational direction. In some embodiments, the rotating structure (e.g., 74 in FIG. 3; 168 in FIGS. 15 and 16) coupled to the propulsor rotor 62 may rotate with one or more of the core rotating structure(s) (e.g., 80 in FIG. 3; 74 and/or 80 in FIGS. 15 and 16) in opposite rotational directions. In some embodiments, the core rotating structures 74 and 80 may rotate in a common rotational direction. In some embodiments, the core rotating structures 74 and 80 may rotate in opposite rotational directions. Various exemplary rotational schemes for the rotating components (e.g., 62, 63, 64, 65, 66 and/or 170) of the aircraft propulsion systems 24A and 24B are outlined in Table 1 below.

TABLE 1

| Propulsion | | Propulsor | LPC | HPC | HPT | LPT | PT rotor |
|---|---|---|---|---|---|---|---|
| System | Propulsion | rotor | rotor | rotor | rotor | rotor | (PTᵢ) |
| Pairing | System | (ORᵢ) | (LPCᵢ) | (HPCᵢ) | (HPTᵢ) | (LPTᵢ) | (optional) |
| 1 | 24A | +1 | +1 | −1 | −1 | +1 | — |
| | 24B | −1 | +1 | −1 | −1 | +1 | — |
| 2 | 24A | +1 | +1 | −1 | −1 | +1 | — |
| | 24B | −1 | +1 | −1 | −1 | −1 | — |
| 3 | 24A | +1 | +1 | −1 | −1 | +1 | — |
| | 24B | −1 | −1 | −1 | −1 | +1 | — |
| 4 | 24A | +1 | +1 | −1 | −1 | +1 | — |
| | 24B | −1 | −1 | +1 | +1 | −1 | — |
| 5 | 24A | +1 | +1 | −1 | −1 | +1 | −1 |
| | 24B | −1 | +1 | −1 | −1 | +1 | −1 |
| 6 | 24A | +1 | +1 | −1 | −1 | +1 | +1 |
| | 24B | −1 | +1 | −1 | −1 | +1 | −1 |

In this table 1, each rotating component (e.g., 62, 63, 64, 65, 66 and/or 170) is assigned a rotational parameter that is equal to
positive one (+1) where the respective rotating component rotates in the first rotational direction; and
negative one (−1) where the respective rotating component rotates in the second rotational direction.

Here, the direction of rotation may be viewed relative to a common reference direction. For example, the direction of rotation may be viewed from a forward facing aft direction along the respective axis 46.

The following formulas may each characterize at least one, some or all of the foregoing rotational schemes in at least the Table 1 above.

$${OR}_{1} + {OR}_{2} + {LPC}_{1} + {LPC}_{2} + {HPC}_{1} + {HPC}_{2} = 0 \qquad Equation 1$$

$${OR}_{1} + {OR}_{2} + {HPT}_{1} + {HPT}_{2} + {LPT}_{1} + {LPT}_{2} = 0 \qquad Equation 2$$

$${OR}_{1} + {OR}_{2} + {HPT}_{1} + {HPT}_{2} + {LPT}_{1} + {LPT}_{2} + {PT}_{1} + {PT}_{2} = 0 \qquad Equation 3$$

$$\vert {OR}_{1} + {OR}_{2} + {HPT}_{1} + {HPT}_{2} + {LPT}_{1} + {LPT}_{2} + {PT}_{1} + {PT}_{2} \vert \leq 2 \qquad Equation 4$$

$$( {OR}_{1} * {LPC}_{1} * {HPC}_{1} ) + ( {OR}_{2} * {LPC}_{2} * {HPC}_{2} ) = 0 \qquad Equation 5$$

$$( {OR}_{1} * {HPT}_{1} * {LPT}_{1} ) + ( {OR}_{2} * {HPT}_{2} * {LPT}_{2} ) = 0 \qquad Equation 6$$

$$( {OR}_{1} * {LPC}_{1} * {HPC}_{1} * {HPT}_{1} * {LPT}_{1} ) + ( {OR}_{2} * {LPC}_{2} * {HPC}_{2} * {HPT}_{2} * {LPT}_{2} ) = 0 \qquad Equation 7$$

$$( {OR}_{1} * {HPT}_{1} * {LPT}_{1} * {PT}_{1} ) + ( {OR}_{2} * {HPT}_{2} * {LPT}_{2} * {PT}_{1} ) = 0 \qquad Equation 8$$

$$( {OR}_{1} * {LPC}_{1} * {HPC}_{1} * {HPT}_{1} * {LPT}_{1} * {PT}_{1} ) + ( {OR}_{2} * {LPC}_{2} * {HPC}_{2} * {HPT}_{2} * {LPT}_{2} * {PT}_{1} ) = 0 \qquad Equation 9$$

The term “ORᵢ” is the rotational parameter for the propulsor rotor 62. The term “LPCᵢ” is the rotational parameter for the LPC rotor 63. The term “HPCᵢ” is the rotational parameter for the HPC rotor 64. The term “HPTᵢ” is the rotational parameter for the HPT rotor 65. The term “LPT;” is the rotational parameter for the LPT rotor 66. The term “PTᵢ” is the rotational parameter for the PT rotor 170. The term “i” is equal to one (1) where the rotating component (e.g., 62, 63, 64, 65, 66 and/or 170) is part of the first aircraft propulsion system 24A. The term “i” is equal to two (2) where the rotating component (e.g., 62, 63, 64, 65, 66 and/or 170) is part of the second aircraft propulsion system 24B. By way of example, the Equation 1 for the propulsion system pairing (1) in the Table 1 above is as follows:

$$1 + - 1 + 1 + 1 + - 1 + - 1 = 0 .$$

In another example, the Equation 9 for the propulsion system pairing (5) in the Table 1 above is as follows:

$$( 1 * 1 * - 1 * - 1 * 1 * - 1 ) + ( - 1 * 1 * - 1 * - 1 * 1 * - 1 ) = 0 .$$

The following formulas may also or alternatively characterize at least one, some or all of the foregoing rotational schemes in at least the Table 1 above.

$$\vert {γ}_{c} / {α}_{c} \vert \leq 0.2 \qquad Equation 10$$

$$\vert {γ}_{c} / {β}_{c} \vert \leq 0.2 \qquad Equation 11$$

$$\vert {γ}_{t} / {α}_{t} \vert \leq 0.2 \qquad Equation 12$$

$$\vert {γ}_{t} / {β}_{t} \vert \leq 0.2 \qquad Equation 13$$

The terms “γ_{c}”, “α_{c}”, “β_{c}”, “γₜ”, “αₜ” and “βₜ” may be determined as follows:

$$Compressor gamma parameter ( {γ}_{c} ) = {α}_{c} + {β}_{c}$$

$$Turbine gamma parameter ( {γ}_{t} ) = {α}_{t} + {β}_{t}$$

$$Compressor alpha parameter ( {α}_{c} ) = {α}_{OR 1} + {α}_{LPC 1} + {α}_{HPC 1}$$

$$Compressor beta area parameter ( {β}_{c} ) = {β}_{OR 2} + {β}_{LPC 2} + {β}_{HPC 2}$$

$$Turbine alpha parameter ( {α}_{t} ) = {α}_{OR 1} + {α}_{HPT 1} + {α}_{LPT 1}$$

$$Turbine beta area parameter ( {β}_{t} ) = {β}_{OR 2} + {β}_{HPT 2} + {β}_{LPT 2}$$

$${α}_{OR 1} = {OR}_{1} * {A}_{OR 1}$$

$${α}_{LPC 1} = {LPC}_{1} * {A}_{LPC 1}$$

$${α}_{HPC 1} = {HPC}_{1} * {A}_{HPC 1}$$

$${α}_{HPT 1} = {HPT}_{1} * {A}_{HPT 1}$$

$${α}_{LPT 1} = {LPT}_{1} * {A}_{LPT 1}$$

$${β}_{OR 2} = {OR}_{2} * {A}_{OR 2}$$

$${β}_{LPC 2} = {LPC}_{2} * {A}_{LPC 2}$$

$${β}_{HPC 2} = {HPC}_{2} * {A}_{HPC 2}$$

$${β}_{HPT 2} = {HPT}_{2} * {A}_{HPT 2}$$

$${β}_{LPT 2} = {LPT}_{2} * {A}_{LPT 2}$$

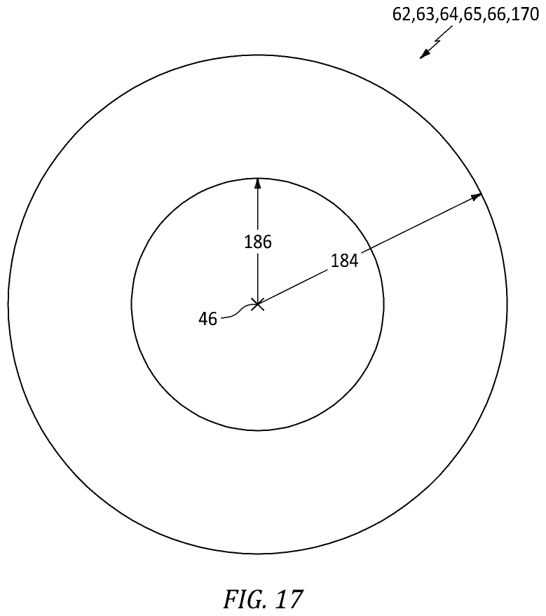

The term “A_{ORi}” is a flow area for the propulsor rotor 62. The term “A_{LPCi}” is a flow area for the LPC rotor 63. The term “AHPCi” is a flow area for the HPC rotor 64. The term “A_{HPTi}” is a flow area for the HPT rotor 65. The term “A_{LPTi}” is a flow area for the LPT rotor 66. As described above, the term “i” is equal to one (1) where the rotating component (e.g., 62, 63, 64, 65, 66, 170) is part of the first aircraft propulsion system 24A. The term “i” is equal to two (2) where the rotating component (e.g., 62, 63, 64, 65, 66, 170) is part of the second aircraft propulsion system 24B. Referring to FIG. 3, the flow area of a respective rotor (e.g., 62, 63, 64, 65, 66, 170) may be measured at a point of highest pressure; e.g., an axial downstream end 174 of the propulsor rotor 62, an axial downstream end 176 of the LPC rotor 63, an axial downstream end 178 of the HPC rotor 64, an axial upstream end 180 of the HPT rotor 65, and an axial upstream end 182 of the LPT rotor 66. Referring to FIG. 17, the flow area of a respective rotor (e.g., 62, 63, 64, 65, 66, 170) may be measured as follows:

$$Rotor Flow Area ( A ) = π * ( {( {R}_{O} )}^{2} - {( {R}_{I} )}^{2} )$$

The term “R_{O}” is an outer radius 184 of a bladed region of the respective rotor (e.g., 62, 63, 64, 65, 66, 170); e.g., at a tip of a respective blade. The term “RI” is an inner radius 186 of the bladed region of the respective rotor (e.g., 62, 63, 64, 65, 66, 170); e.g., at a base of the respective blade.

While the equations 10-13 are described above as being equal to or less than 0.2, the present disclosure is not limited to such exemplary values. In other embodiments, for example, any one or more or each of the equations 10-13 may be equal to or less than 0.1. In still other embodiments, any one or more or each of the equations 10-13 may be equal to or less than 0.05.

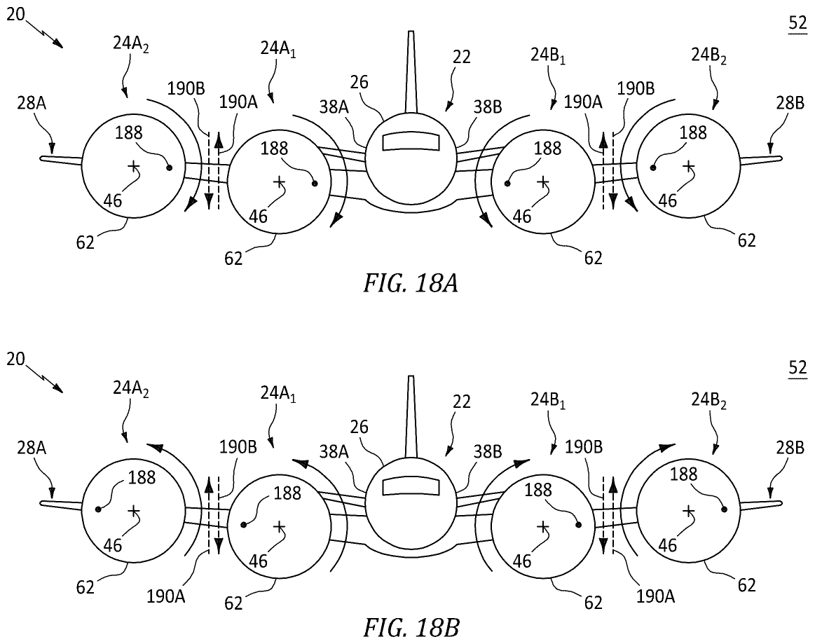

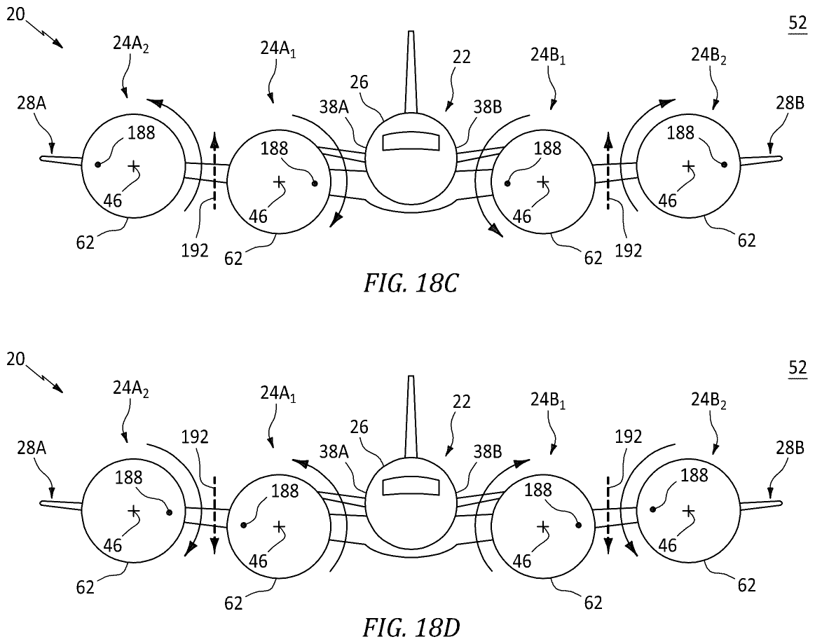

The rotational schemes characterized by the foregoing formulas are particularly useful in providing the (e.g., companion) aircraft propulsion systems 24A and 24B with the symmetric rotating pattern of FIG. 5A or 5B (or FIGS. 18A-D), while reducing propulsion system complexity, reducing research and development efforts, reducing spare part holding requirements, reducing maintenance and/or inspection knowledge requirements, etc. The propulsion system pairing (4) in the Table 1 above may also reduce propulsion system certification testing requirements since the second aircraft propulsion system 24B may be a (e.g., exact) mirror image of the first aircraft propulsion system 24A. Therefore, although like rotating components of the aircraft propulsion systems 24 rotate in opposite directions, it is contemplated the aircraft propulsion systems 24 will operate with common operational parameters, limits, etc.

In some embodiments, a select rotational scheme which provides the (e.g., companion) aircraft propulsion systems 24A and 24B with the symmetric rotating pattern of FIG. 5A or 5B (or FIGS. 18A-D) may satisfy any single one of the foregoing equations 1-13. In other embodiments, a select rotational scheme which provides the (e.g., companion) aircraft propulsion systems 24A and 24B with the symmetric rotating pattern of FIG. 5A or 5B (or FIGS. 18A-D) may satisfy two or more of the foregoing equations 1-13. For example, any one of the equations 10-13 may be paired with one or more of the equations 1-9. In another example, any two or more or all of the equations 10-13 may be paired with one another. In still another example, any one or more of the equations 1-4 may be paired with any one or more of the equations 5-8. The present disclosure, of course, is not limited to the foregoing exemplary equation pairing.

The aircraft propulsion system 24 of FIGS. 3, 15 and 16 and its propulsion section 54 are described above with a tractor configuration; e.g., where the propulsor rotor 62 is disposed at or otherwise near the propulsion system forward end 48. It is contemplated, however, the propulsion section 54 may alternatively be disposed at or otherwise near the propulsion system aft end 50 to provide a pusher fan configuration.

The guide vane structure 90 is described above as a fixed (e.g., non-rotatable) guide vane structure. It is contemplated, however, the guide vane structure 90 may alternatively be selectively rotatable about the axis 46. With such an arrangement, the respective aircraft propulsion system 24 may be configured as an open rotor propulsion system with a swirl recovery blade (SRB) open rotor architecture. More particularly, the respective aircraft propulsion system 24 may operate as: (A) a counter-rotating open rotor (CROR) propulsion system during a dual rotor mode of operation (e.g., when both the propulsor rotor 62 and the structure 90 are counter-rotating about the axis 46); and (B) a single open rotor and swirl recovery vane (SRV) propulsion system during a single rotor mode of operation (e.g., when the propulsor rotor 62 is rotating and the structure 90 is rotationally fixed about the axis 46). Note, when the guide vane structure 90 is configured to selectively rotate about the axis 46, the moving guide vanes 110 operate as propulsor blades.

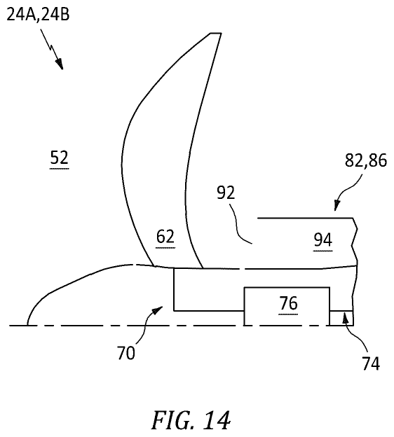

The aircraft propulsion system 24 of FIGS. 3, 15 and 16 and its propulsion section 54 are described as including the guide vane structure 90 with an SRV or SRB configuration. The present disclosure, however, is not limited to such an exemplary propulsion system configuration. For example, each aircraft propulsion system 24 may alternatively be configured without an open guide vane structure. Each aircraft propulsion system 24 may thereby be configured as a single rotor (SR) open rotor propulsion system, for example, as shown in FIG. 14. In another example, each aircraft propulsion system 24 may alternatively be configured with a set of the open propulsor rotors (e.g., counter-rotating propulsor rotors) operatively coupled to the turbine engine 61 (see FIGS. 3, 15 and 16) through the geartrain 76. Each aircraft propulsion system 24 may thereby be configured as a counter-rotating open rotor (CROR) propulsion system.

While the aircraft 20 is shown in FIGS. 1, 2, 5A and 5B with a single pair of the aircraft propulsion systems 24A and 24B, the present disclosure is not limited to such an exemplary aircraft arrangement. For example, referring to FIGS. 18A-D, the aircraft 20 may alternatively include multiple pairs (e.g., two pairs) of the aircraft propulsion systems 24 mounted to the aircraft airframe 22. More particularly, a first set of two (2) aircraft propulsion systems 24A₁ and 24A₂ (generally referred to as “24A”) may be mounted to the aircraft airframe 22 at the first side 38A of the aircraft fuselage 26. A second set of two (2) aircraft propulsion systems 24B₁ and 24B₂ (generally referred to as “24B”) may be mounted to the aircraft airframe 22 at the second side 38B of the aircraft fuselage 26.

Similar to the aircraft propulsion systems 24 in FIGS. 5A and 5B, the aircraft propulsion systems 24 of FIGS. 18A-D may be configured to provide various symmetric rotating patterns when viewed, for example, in the lateral reference plane. For example, in FIG. 18A, the propulsor rotors 62 of the inboard aircraft propulsion systems 24A₁ and 24B₁ rotate in the inboard down-down symmetric rotating pattern. The propulsor rotors 62 of the outboard aircraft propulsion systems 24A₂ and 24B₂ also rotate in the inboard down-down symmetric rotating pattern. In FIG. 18B, the propulsor rotors 62 of the inboard aircraft propulsion systems 24A₁ and 24B₁ rotate in the inboard up-up symmetric rotating pattern. The propulsor rotors 62 of the outboard aircraft propulsion systems 24A₂ and 24B₂ also rotate in the inboard up-up symmetric rotating pattern. In FIG. 18C, the propulsor rotors 62 of the inboard aircraft propulsion systems 24A₁ and 24B₁ rotate in the inboard down-down symmetric rotating pattern. The propulsor rotors 62 of the outboard aircraft propulsion systems 24A₂ and 24B₂ rotate in the inboard up-up symmetric rotating pattern. In FIG. 18D, the propulsor rotors 62 of the inboard aircraft propulsion systems 24A₁ and 24B₁ rotate in the inboard up-up symmetric rotating pattern. The propulsor rotors 62 of the outboard aircraft propulsion systems 24A₂ and 24B₂ rotate in the inboard down-down symmetric rotating pattern.

In FIGS. 18A and 18B, the propulsor rotors 62 of the aircraft propulsion systems 24A₁ and 24A₂ are co-rotating. The propulsor rotors 62 of the aircraft propulsion systems 24B₁ and 24B₂ are also co-rotating. With such co-rotating propulsor rotors 62, centers of thrust 188 associated with those co-rotating propulsor rotors 62 are disposed to a common lateral side of their propulsion system axes 46. Here, shearing may occur between the air propelled by the respective co-rotating propulsor rotors 62 as exemplified by arrows 190A and 190B (generally referred to as “190”). In FIGS. 18C and 18D, the propulsor rotors 62 of the aircraft propulsion systems 24A₁ and 24A₂ are counterrotating. The propulsor rotors 62 of the aircraft propulsion systems 24B₁ and 24B₂ are also counterrotating. With such counterrotating propulsor rotors 62, the centers of thrust 188 associated with those counterrotating propulsor rotors 62 are disposed to opposing lateral sides of their propulsion system axes 46. Here, the air propelled by the respective co-rotating propulsor rotors 62 may move in a common direction (between the respective propulsor rotors 62) as exemplified by arrows 192.

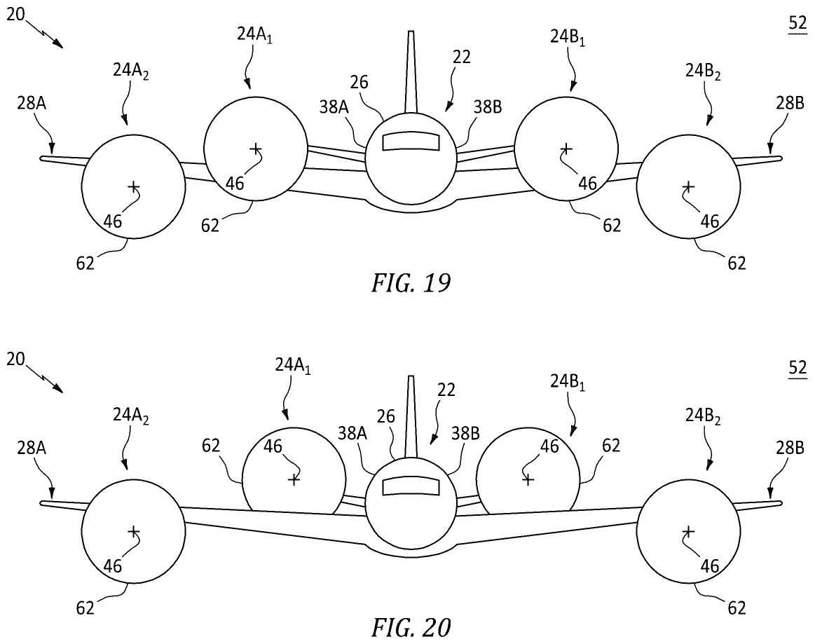

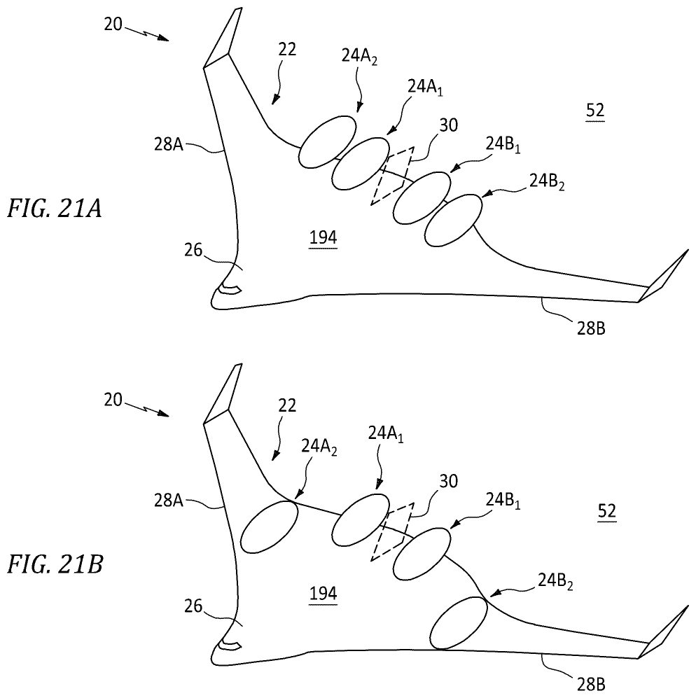

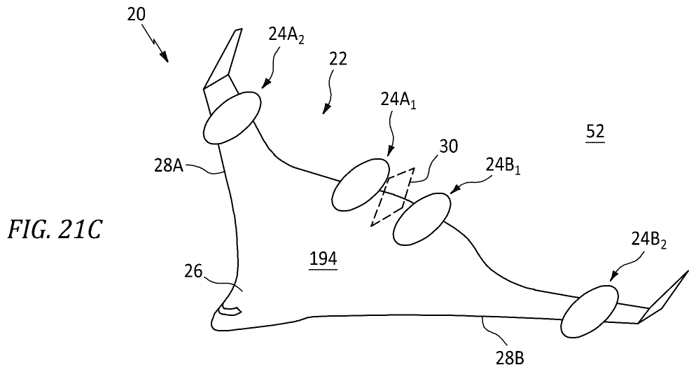

In some embodiments, referring to FIGS. 18A-D, the aircraft propulsion systems 24 may be wing mounted aircraft propulsion systems. The aircraft propulsion systems 24A of FIGS. 18A-D, for example, are mounted to the first aircraft wing 28A. The aircraft propulsion systems 24B of FIGS. 18A-D are mounted to the second aircraft wing 28B. The aircraft propulsion systems 24 may be mounted in a similar manner with respect to the aircraft airframe 22. The propulsion system axes 46 of the aircraft propulsion systems 24 of FIGS. 18A-D, for example, may be respectively vertically aligned with the aircraft wings 28. Alternatively, referring to FIG. 19, the propulsion system axes 46 of at least one pair of the aircraft propulsion systems 24 (e.g., 24A₁ and 24B₁) may be located vertically above the respective aircraft wings 28 or otherwise offset vertically upwards. In addition or alternatively, the propulsion system axes 46 of at least one pair of the aircraft propulsion systems 24 (e.g., 24A₂ and 24B₂) may be located vertically below the respective aircraft wings 28 or otherwise offset vertically downwards. The present disclosure, however, is not limited to such exemplary wing mounted aircraft propulsion systems. For example, referring to FIG. 20, at least one pair of the aircraft propulsion systems 24 (e.g., 24A₁ and 24B₁) may alternatively be mounted to the aircraft fuselage 26 and, thus, independent of the aircraft wings 28. In other examples, referring to FIGS. 21A-C, each pair of the aircraft propulsion systems 24 may be mounted at a top side 194 of the aircraft 20. The mounting arrangements of FIGS. 21A-C may be particularly useful where the aircraft 20 is configured as a blended wing body (BWB) aircraft.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An assembly for an aircraft, comprising:
a first propulsion system including a first open propulsor rotor, a first open guide vane structure, a first engine core and a first geartrain, the first engine core comprising a first rotating structure configured to drive rotation of the first open propulsor rotor in a first rotational direction about a first axis through the first geartrain, the first rotating structure comprising a first turbine rotor, and the first geartrain comprising a first plurality of epicyclic gear systems operatively coupled in series between the first rotating structure and the first open propulsor rotor; and
a second propulsion system including a second open propulsor rotor, a second open guide vane structure, a second engine core and a second geartrain, the second engine core comprising a second rotating structure configured to drive rotation of the second open propulsor rotor in a second rotational direction about a second axis through the second geartrain, the second rotating structure comprising a second turbine rotor, and the second geartrain comprising a second plurality of epicyclic gear systems operatively coupled in series between the second rotating structure and the second open propulsor rotor.

2. The assembly of claim 1, wherein
the first plurality of epicyclic gear systems comprise a first star gear system and a first planetary gear system; and
the second plurality of epicyclic gear systems comprise a second star gear system and a third star gear system.

3. The assembly of claim 1, wherein the first plurality of epicyclic gear systems comprises a first gear system and a second gear system, and the first gear system includes
a sun gear configured to rotate about the first axis;
a ring gear configured to rotate about the first axis;
a plurality of intermediate gears meshed with and radially between the sun gear and the ring gear; and
a stationary carrier, each of the plurality of intermediate gears rotatably mounted to the stationary carrier.

4. The assembly of claim 3, wherein the first rotating structure is operatively coupled to the first geartrain through the sun gear.

5. The assembly of claim 3, wherein the second gear system is operatively coupled to the first gear system through the ring gear.

6. The assembly of claim 1, wherein the first plurality of epicyclic gear systems comprises a first gear system and a second gear system, and the second gear system includes
a sun gear configured to rotate about the first axis;
a stationary ring gear;
a plurality of intermediate gears meshed with and radially between the sun gear and the stationary ring gear; and
a carrier configured to rotate about the first axis, each of the plurality of intermediate gears rotatably mounted to the carrier.

7. The assembly of claim 6, wherein the first open propulsor rotor is operatively coupled to the first geartrain through the carrier.

8. The assembly of claim 6, wherein the first gear system is operatively coupled to the second gear system through the sun gear.

9. The assembly of claim 1, wherein the first open guide vane structure includes a plurality of open guide vanes arranged circumferentially about the first axis, and the first open guide vane structure is axially next to and downstream of the first open propulsor rotor.

10. The assembly of claim 1, wherein a configuration of the first rotating structure is identical to a configuration of the second rotating structure.

11. The assembly of claim 1, further comprising an aircraft fuselage arranged laterally between the first propulsion system and the second propulsion system.

12. The assembly of claim 1, further comprising an aircraft fuselage, the first propulsion system arranged laterally between the aircraft fuselage and the second propulsion system.

13. The assembly of claim 1, further comprising:
a third propulsion system including a third open propulsor rotor, a third open guide vane structure, a third engine core and a third geartrain, the third engine core comprising a third rotating structure configured to drive rotation of the third open propulsor rotor in the first rotational direction about a third axis through the third geartrain, and the third rotating structure comprising a third turbine rotor; and
a fourth propulsion system including a fourth open propulsor rotor, a fourth open guide vane structure, a fourth engine core and a fourth geartrain, the fourth engine core comprising a fourth rotating structure configured to drive rotation of the fourth open propulsor rotor in the second rotational direction about a fourth axis through the fourth geartrain, and the fourth rotating structure comprising a fourth turbine rotor.

14. The assembly of claim 13, further comprising:
an aircraft fuselage extending laterally between a first side and a second side;
the first propulsion system and the second propulsion system arranged to the first side of the aircraft fuselage; and
the third propulsion system and the fourth propulsion system arranged to the second side of the aircraft fuselage.

15. The assembly of claim 13, further comprising:
an aircraft fuselage extending laterally between a first side and a second side;
the first propulsion system and the third propulsion system arranged to the first side of the aircraft fuselage; and
the second propulsion system and the fourth propulsion system arranged to the second side of the aircraft fuselage.

16. An assembly for an aircraft, comprising:
a first propulsion system including a first open propulsor rotor and a first engine core, the first open propulsor rotor comprising a first number of first open propulsor blades arranged in an array about a first axis, and the first engine core comprising a first rotating structure configured to drive rotation of the first open propulsor rotor in a first rotational direction about the first axis, wherein the first number is equal to or greater than nine;
a second propulsion system including a second open propulsor rotor and a second engine core, the second open propulsor rotor comprising a second number of second open propulsor blades arranged in an array about a second axis, and the second engine core comprising a second rotating structure configured to drive rotation of the second open propulsor rotor in the first rotational direction about the second axis, wherein the second number is equal to or greater than nine;
a third propulsion system including a third open propulsor rotor and a third engine core, the third open propulsor rotor comprising a third number of third open propulsor blades arranged in an array about a third axis, and the third engine core comprising a third rotating structure configured to drive rotation of the third open propulsor rotor in a second rotational direction about the third axis, wherein the third number is equal to or greater than nine; and
a fourth propulsion system including a fourth open propulsor rotor and a fourth engine core, the fourth open propulsor rotor comprising a fourth number of fourth open propulsor blades arranged in an array about a fourth axis, and the fourth engine core comprising a fourth rotating structure configured to drive rotation of the fourth open propulsor rotor in the second rotational direction about the fourth axis, wherein the fourth number is equal to or greater than nine.

17. The assembly of claim 16, further comprising:
an aircraft fuselage extending laterally between a first side and a second side;
the first propulsion system located laterally between the second propulsion system and the first side of the aircraft fuselage; and
the third propulsion system located laterally between the fourth propulsion system and the second side of the aircraft fuselage.

18. The assembly of claim 16, further comprising:
an aircraft fuselage extending laterally between a first side and a second side;
the first propulsion system located laterally between the third propulsion system and the first side of the aircraft fuselage; and
the second propulsion system located laterally between the fourth propulsion system and the second side of the aircraft fuselage.

19. The assembly of claim 16, wherein
the first propulsion system further includes a first open guide vane structure axially next to and downstream of the first open propulsor rotor;
the second propulsion system further includes a second open guide vane structure axially next to and downstream of the second open propulsor rotor;
the third propulsion system further includes a third open guide vane structure axially next to and downstream of the third open propulsor rotor; and
the fourth propulsion system further includes a fourth open guide vane structure axially next to and downstream of the fourth open propulsor rotor.

20. An assembly for an aircraft, comprising:
a first propulsion system including a first open propulsor rotor, a first open guide vane structure and a first engine core, the first engine core comprising a first rotating structure configured to drive rotation of the first open propulsor rotor in a first rotational direction about a first axis;
a second propulsion system including a second open propulsor rotor, a second open guide vane structure and a second engine core, the second engine core comprising a second rotating structure configured to drive rotation of the second open propulsor rotor in the first rotational direction about a second axis;
a third propulsion system including a third open propulsor rotor, a third open guide vane structure and a third engine core, the third engine core comprising a third rotating structure configured to drive rotation of the third open propulsor rotor in a second rotational direction about a third axis; and
a fourth propulsion system including a fourth open propulsor rotor, a fourth open guide vane structure and a fourth engine core, the fourth engine core comprising a fourth rotating structure configured to drive rotation of the fourth open propulsor rotor in the second rotational direction about a fourth axis.
